(19) United States
(12) Patent Application Publication
(10) Pub. No.: US 2025/0019277 A1
(43) Pub. Date: Jan. 16, 2025

(54) Sequentially Stacked Multi-Stage Desalination System and Method

(71) Applicant: Massachusetts Institute of Technology, Cambridge, MA (US)

(72) Inventors: Jongyoon Han, Bedford, MA (US); Junghyo Yoon, Malden, MA (US)

(21) Appl. No.: 18/714,486

(22) PCT Filed: Oct. 27, 2022
(86) PCT No.: PCT/US2022/047975

§ 371 Date: May 29, 2024

Related U.S. Application Data
(60) Provisional application No. 63/294,475, filed on Dec. 29, 2021.

(51) Int. Cl. C02F 1/469; B01D 57/02; B01D 61/50; C02F 103/08

(52) U.S. Cl. CPC C02F 1/4696; B01D 57/02; B01D 61/50; C02F 1/4693; B01D 2311/04; B01D 2313/345; B01D 2313/367; B01D 2317/022; B01D 2317/025; B01D 2317/06; C02F 2103/08; C02F 2201/009; C02F 2201/46; C02F 2301/08

(57) ABSTRACT

A sequentially stacked multi-stage desalination system includes a single pair of electrodes, including an anode and a cathode; at least one ion concentration polarization device; and at least one electrodialysis device coupled with the ion concentration polarization device and configured to receive liquid flow from the ion concentration polarization device. Each ion concentration device and electrodialysis device is positioned between the anode and the cathode.

### GOVERNMENT SUPPORT

This invention was made with government support under Grant No. W911NF-13-D-0001, awarded by the Army Research Office. The US Government has certain rights in the invention.

### BACKGROUND

The discussion of the background state of the art, below, may reflect hindsight gained from the disclosed invention(s); and these characterizations are not necessarily admitted to be prior art.

The global water shortage is continuously worsening due to climate change and increased human activity. Construction of seawater desalination plants has increased in recent decades to meet the need, especially for coastal cities. A seawater desalination plant is a good solution for people in urban areas, where necessary infrastructure investment is easily justified. However, it is generally not feasible for people who live in sparsely populated, remote, resource-limited environments, such as small and medium-sized islands, maritime vessels; refugees from natural or man-made disasters; or soldiers carrying out long-term military operations. Delivering bottled water typically is still the only practical option to satisfy the need for drinking water for the basic survival of these populations. Delivering bottled water, however, is energy- and cost-intensive, detrimental to marine ecosystems (due to discarded bottles), and creates health concerns from environmental microplastic contamination.

Portable, easy-to-use desalination systems with an appropriate production rate and energy efficiency would be an ideal solution for these challenges. Yet, engineering practical small-scale desalination systems has been deceptively challenging, despite many prior efforts. Only reverse osmosis (RO)-based portable desalination units are currently on the market with the following specifications: 3˜14 Wh/L of specific energy consumption (SEC), 24˜32 L/h of production rate, and a weight of 24˜ 62 kg. Notwithstanding the reasonably good SEC of RO technology, these systems are too heavy (>20 kg) and power-intensive (100˜400 W) for the aforementioned remote applications. RO desalination of seawater requires high-pressure pumping, and miniaturization of high-pressure pumping severely compromises energy efficiency. Importantly, the RO process is susceptible to membrane fouling, which may require frequent membrane exchange and maintenances, limiting the operational flexibility of this process in the field. Recently, a multi-stage solar still device successfully converted seawater into drinking water without using additional equipment, such as pumps and power supplies, but achieved only ˜0.02 L/h of production rate, which is too small to be of practical use.

In desalination technology, device size and energy efficiency involve a trade-off; a smaller device requires larger energy consumption. The miniaturization of desalination devices has been vigorously investigated to develop a portable desalination unit. Electrodialysis (ED) offers scalability of production rate, process tunability depending on feed salinity, and self-cleanability by polarity reversal. Conventional electrodialysis (FIG. 11) utilizes an alternating stack of a CEM, an ED spacer, an anion exchange membrane (AEM), and an EC spacer between one pair of electrodes. The diluate stream is formed in the ED spacer placed on the cathodic side of AEM, and the concentrate stream is formed in the other direction. ED offers the advantage of flexible and efficient operation at various production rates and feed salinities. In addition, electromembranes can be used long-term with self-cleanability via polarity reversal. Since the invention of ED in the 1950s, the energy efficiency of ED has improved continuously. One of the critical limitations of ED, however, is that it cannot remove suspended solids, such as bacteria and organic compounds, which is typically an essential step in any desalination systems.

We previously proposed an ion concentration polarization (ICP) desalination process using only CEMs and implemented it in various lab-scale prototypes. It was shown that the ICP process using only CEMs, which are less fouling-prone than AEMs, leads to improvement of the current utilization (˜20%) compared to ED because of the electrical mobility of chloride (6.88×10⁻⁸ m²/Vs) being higher than that of sodium (4.98×10⁻⁸ m²/Vs), which leads to a thicker diffusion layer on CEM (δ_{D,CEM}) compared to that on AEM (δ_{D,AEM}) under a current application. It was also demonstrated that the ICP desalination process can remove the total suspended solids (TSS), such as bacteria and oil droplets, along with the total dissolved salts (TDS). However, the current-state-of-the-art ICP process has suffered from poor energy efficiency in complete desalination. generally rendering it ill-suited to compete with current reverse osmosis-based portable desalination units.

### SUMMARY

A sequentially stacked multi-stage desalination system and a method for its use to produce purified diluate are described herein, where various embodiments of the apparatus and methods may include some or all of the elements, features and steps described herein.

A sequentially stacked multi-stage desalination system can include a single pair of electrodes, comprising an anode and a cathode; at least one ion concentration polarization (ICP) device; and at least one electrodialysis (ED) device. In particular exemplifications, a two-stage ion concentration polarization device is used, including a first-stage and second-stage ion concentration polarization device connected in series for liquid flow from the first-stage ion concentration polarization device to the second-stage ion concentration polarization device. In this exemplification, the electrodialysis device is coupled with the second-stage ion concentration polarization device and configured to receive liquid flow for the second-stage ion concentration polarization device. The first-stage ion concentration device, the second-stage ion-concentration device and the electrodialysis device are all positioned between the same anode and cathode.

In other embodiments, two or more electrodialysis devices are used in a staged arrangement. Other combinations of staged ion concentration polarization devices and electrodialysis devices are employed, with each stage being positioned by between the shared anode and cathode.

A method for sequentially stacked multi-stage desalination using the above-described desalination system includes flowing an aqueous saline solution into at least one ion concentration polarization device. In a two-stage configuration of ion concentration polarization devices, ions are extracted from the aqueous saline solution in the first-stage ion concentration polarization device to produce a concentrated brine and a first-stage diluate. In this embodiment, the first-stage diluate flows from the first-stage ion concentration polarization device into a second-stage ion concentration polarization device. Additional ions are from the first-stage diluate in the second-stage ion concentration polarization device to produce additional concentrated brine and a second-stage diluate. The second-stage diluate flows from the second-stage ion concentration polarization device into the electrodialysis device. Additional ions are extracted from the second-stage diluate in the electrodialysis device to produce a purified diluate.

In contrast with the vast majority of desalination research conducted thus far, which has focused on increasing the energy efficiency of the process, we focused instead on engineering portable desalination systems targeting careful optimization between energy efficiency and the overall system size (more specifically, membrane area efficiency). There is a fundamental trade-off between separation energy efficiency and separation speed (processing rate). Therefore, one cannot achieve the highest energy efficiency in small-scale systems. Instead, other functional considerations, such as co-removal of TSS and TDS, operation by battery or solar panel, and small system size with high membrane area efficiency, drove these engineering efforts. With this consideration in mind, we have engineered and validated a fully integrated and deployable portable seawater desalination system, including a battery and controller for stand-alone operation. The system can be configured to offer two-stage ICP and single-stage ED processes operated by a single pair of electrodes, providing optimal natural seawater desalination and suspended solids removal simultaneously. Instead of seeking the highest energy efficiency, which will inherently require large-scale membranes or a low production rate, we chose to optimize powering the system using batteries or solar panels comfortably while achieving reasonable production rates given the system size. The optimal design and working conditions of the system configuration were selected with the help of the predictive models trained by experimental results of single-stage ICP and ED. We experimentally tested the prototype system for treating a wide range of feed salinity (brackish water, 2.5˜10 g/L, and seawater, 30˜45 g/L), removing TSS [up to 50 nephelometric turbidity units (NTU)] simultaneously. Also, two different modes of field operation, a gravity-fed system (i.e., no pump operation) and a fully automated portable desalination system, were demonstrated using natural seawater sampled directly from the beach.

The sequentially stacked multi-stage seawater desalination system described herein can be highly desirable in terms of solving water challenges in rural areas and disaster situations. The sequentially stacked multi-stage electromembrane process provides for dissolved and suspended solids removal via an energy-efficient portable desalination unit. We demonstrate a field-deployable desalination system with multi-stage electromembrane processes, composed of two stages of ion concentration polarization and one stage of electrodialysis, to convert brackish water and seawater to drinkable water. Nevertheless, other combinations of one or more stages of ion concentration polarization devices and electrodialysis devices can be employed (e.g., two stages of ICP followed by two stages of ED or three stages of ICP followed by one stage of ED). A data-driven predictive model is used to optimize the multi-stage configuration, and the model predictions show good agreement with the experimental results. The exemplary portable system can desalinate brackish water and seawater (2.5˜ 45 g/L) into drinkable water [defined by World Health Organization (WHO) guidelines], with the energy consumptions of 0.4˜ 4 (brackish water) and 15.6˜ 26.6 Wh/L (seawater), respectively. In addition, the exemplary process can also reduce suspended solids by at least a factor of 10 from the source water, resulting in crystal-clear water (<1 NTU) even from source water with turbidity higher than 30 NTU (i.e., seawater made cloudy by the tide). We built a fully integrated prototype (with controller, pumps, and battery) packaged into a portable unit (with dimensions of 42×33.5×19 cm³, a mass of 9.25 kg, and a 0.33 L/hr production rate) controlled by a smartphone, which was tested for battery-powered field operation. The demonstrated portable desalination system is believed to be unprecedented in size, efficiency, and operational flexibility. It can, therefore, address unique water challenges in remote, resource-limited regions of the world.

In various exemplifications, the system can be particularly compact (e.g., with all dimensions less than 1 meter or 0.5 meters) and lightweight (e.g., with a mass of less than 20 kg or even less than 10 kg).

### BRIEF DESCRIPTION OF THE DRAWINGS

FIG. 1 is a schematic illustration of a sequentially stacked multi-stage desalination system, including a source of aqueous saline solution (e.g., seawater), a cathode, an anode, a first-stage ion concentration polarization (ICP) device, a second-stage ion concentration polarization device, an electrodialysis (ED) device, a diluate (e.g., drinking water) storage tank, and a brine discharge tank.

FIG. 2 is a schematic illustration of transport of dissolved and suspended solids in an ion concentration polarization (ICP) process. Arcs 54 (bottom) and 56 (top) indicate the depletion layer and the concentration boundary layer, respectively.

FIG. 3 is a schematic illustration of transport of dissolved and suspended solids in electrodialysis (ED).

FIG. 4 is a schematic illustration of an ICP process with a bifurcate spacer (Bi-ICP).

FIG. 5 is a schematic illustration of an ICP process with a trifurcate spacer (Tri-ICP).

FIG. 6 is a schematic illustration of an ICP process with a return-flow spacer (RF-ICP).

FIG. 7 is a schematic illustration of an ICP process with a counter-flow spacer (CF-ICP).

FIG. 8 plots power consumption according to the salt removal ratio (SRR) with a feed salinity concentration of 70 kppm for an ICP desalination system with 30 cm of effective membrane length and 0.5 mm/s of flow velocity.

FIG. 9 plots power consumption according to the salt removal ratio (SRR) with a feed salinity concentration of 100 kppm for an ICP desalination system with 30 cm of effective membrane length and 0.5 mm/s of flow velocity.

FIG. 10 plots power consumption according to the salt removal ratio (SRR) with a feed salinity concentration of 160 kppm for an ICP desalination system with 30 cm of effective membrane length and 0.5 mm/s of flow velocity.

FIG. 11 is a schematic illustration of a single ICP stage with n cells.

FIG. 12 is a schematic illustration of a single ED stage with m cells, with a legend for the graphics used in FIGS. 14 and 15 inset at upper right.

FIG. 13 is a schematic illustration of serially connected ICP stages with reuse of the diluate stream for a desalination application.

FIG. 14 is a schematic illustration of sequentially stacked ICP stages with the recirculation of diluate streams for desalination. n and N indicate the number of cells in ICP stage and the number of sequentially stacked ICP stages, respectively.

FIG. 15 is a schematic illustration of sequentially stacked ICP stages with the recirculation of concentrate streams for concentration. n and N indicate the number of cells in the ICP stage and the number of sequentially stacked ICP stages, respectively.

FIG. 16 is a schematic illustration of sequentially stacked counter-flow ICP stages with the recirculation of diluate streams for desalination. Each stage is stacked in an alternating direction of liquid flow to produce a counter-flow from one stage to the next. n and N indicate the number of cells in an ICP stage and the number of sequentially stacked ICP stages, respectively.

FIG. 17 is a schematic illustration of sequentially stacked counter-flow ICP stages with the recirculation of concentrate streams for concentration. Each stage is stacked alternatively to have a counter-flow direction. n and N indicate the number of cells in an ICP stage and the number of sequentially stacked ICP stages, respectively.

FIG. 18 is a schematic illustration of sequentially stacked ICP and ED stages in a parallel-flow arrangement.

FIG. 19 is a schematic illustration of sequentially stacked ICP and ED stages in the counter-flow arrangement.

FIG. 20 is a schematic illustration of an analytic experimental system and variables to optimize the 2ICP/ED process.

FIG. 21 includes a schematic illustration of the 2ICP/ED device and plots of the change in current utilization (CU), current, and specific energy consumption (SEC) with respect to the change in m_{S1} in an experimental evaluation of a 2ICP/ED process.

FIG. 22 includes a schematic illustration of the 2ICP/ED device and plots of the change in current utilization (CU), current, and specific energy consumption (SEC) with respect to the change in m_{S2} in an experimental evaluation of a 2ICP/ED process.

FIG. 23 includes a schematic illustration of the 2ICP/ED device and plots of the change in current utilization (CU), current, and specific energy consumption (SEC) with respect to the change in Q_{S3,D} in an experimental evaluation of a 2ICP/ED process.

FIG. 24 plots the salt removal rate (SRRate) of each stage in a 2ICP/ED process as a function of m_{S1}.

FIG. 25 plots the salt removal rate (SRRate) of each stage in a 2ICP/ED process as a function of m_{S2}.

FIG. 26 plots the salt removal rate (SRRate) of each stage in a 2ICP/ED process as a function of Q_{S3,D}.

FIG. 27 plots the change in specific energy consumption (SEC) to produce drinking water as a function of feed salinity.

FIG. 28 is a plot showing the total suspended solids (TSS) removal ability of the process, its desalination performance, and the durability of the 2ICP/ED process.

FIG. 29 is a plot evidencing the scalability of the 2ICP/ED process.

FIG. 30 plots the salinity of the diluate and the SEC in a long-term operation test.

FIG. 31 includes turbidity plots that demonstrate the suspended solids removal by single-stage ICP (1ICP), two-stage ICP (2ICP), and 2ICP/ED. The gray shaded area indicates the range of crystal-clear water (<1 NTU).

FIG. 32 is a schematic illustration of a system and operation where the concentrate streams are re-used as rinse flow for the anode and the cathode.

FIG. 33 is a schematic illustration of an assembled desalination unit and a remoted controller.

FIG. 34 is a plot representing the salinity variation of a diluate stream in a single-stage ICP process (S_{ICP,D}).

FIG. 35 is a plot representing the measured voltage drop at the ICP cells (V_{ICP,cells}) as a function of the current at various diluate stream flow rates (Q_{ICP,D}) in a single-stage ICP process.

FIG. 36 is a plot representing the specific energy consumption by ICP cells (SEC_{ICP,cells}) and electrodes (SEC_{elec}) to achieve a certain SRR.

FIG. 37 is a plot representing the salinity variation of a diluate stream in ED (S_{ED,D}). The gray shaded areas in FIGS. 34 and 37 indicate the difference between the ideal S_{D} (CU_{ICP,Ideal}=1.234 and CU_{ED,Ideal}=1 for seawater) and actual S_{D} for the ICP and

ED process.

FIG. 38 is a plot representing the measured voltage drop at an ED cell (V_{ED,cell}) as a function of the current at various feed salinities (S_{ED,F}).

FIG. 39 represents the specific energy consumption by the ED cell (SEC_{ED,cell}).

FIG. 40 is a plot of the change in current utilization of ICP (CU_{ICP}) as a function of current on the system (I) with respect to the change in flow rate of diluate stream (Q_{ICP,D}).

FIG. 41 is a plot of the voltage drop by electrode pair (V_{elec}).

FIG. 42 is a schematic diagram of the experimental setup to validate a model prediction for an energy-efficient multistage (2ICP/ED) configuration.

FIG. 43 plots experimental results for the 2ICP/ED module regarding the change in CU, current, and SEC with respect to a change in m_{S1}.

FIG. 44 plots experimental results for the 2ICP/ED module regarding the change in CU, current, and SEC with respect to a change in m_{S2}.

FIG. 45 plots experimental results for the 2ICP/ED module regarding the change in CU, current, and SEC with respect to a change in Q_{sys,D}. In FIGS. 43-45, the solid circles represent experimentally applied current (Iₑₓₚ), and the dotted lines represent the current theoretically required (I_{ideal}, assuming ideal permselectivity) to convert seawater to drinkable water, respectively.

FIG. 46 illustrates the change in salinity of outlets and the salt removal rate (SRRate) of each stage in a 2ICP/ED process as a function of m_{S1}.

FIG. 47 illustrates the change in salinity of outlets and the salt removal rate (SRRate) of each stage in a 2ICP/ED process as a function of m_{S2}.

FIG. 48 illustrates the change in salinity of outlets and the salt removal rate (SRRate) of each stage in a 2ICP/ED process as a function of Q_{sys,D}.

FIG. 49 is a schematic illustration of a pumping-free, gravity-fed seawater desalination operation in an experimental setting.

FIG. 50 plots the real-time change of voltage, current, and salinity of the diluate stream from operation of a system matching that shown in FIG. 49.

FIG. 51 plots the salinity of the feed, product water (diluate) and brine produced by a multi-stage (2ICP/ED) desalination system fed with seawater.

FIG. 52 plots the pH of feed, product water, and brine produced via the same process as in FIG. 51.

FIG. 53 plots the ionic composition in product water (diluate) produced via the process as in FIGS. 51 and 52.

FIG. 54 plots the power consumption and the specific energy consumption (SEC) of the sequentially stacked multi-stage desalination unit via the same process as in FIGS. 51-53.

In the accompanying drawings, like reference characters refer to the same or similar parts throughout the different views; and apostrophes are used to differentiate multiple instances of the same item or different embodiments of items sharing the same reference numeral. The drawings are not necessarily to scale; instead, an emphasis is placed upon illustrating particular principles in the exemplifications discussed below.

For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. The term, “about,” can mean within ±10% of the value recited. In addition, where a range of values is provided, each subrange and each individual value between the upper and lower ends of the range is contemplated and therefore disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as those introduced with the articles, “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

### Overview of System:

Described herein is a sequentially stacked multi-stage desalination system for use in a sequentially stacked multi-stage electromembrane process, which can be used, e.g., for saline water desalination and low-abundant source concentration.

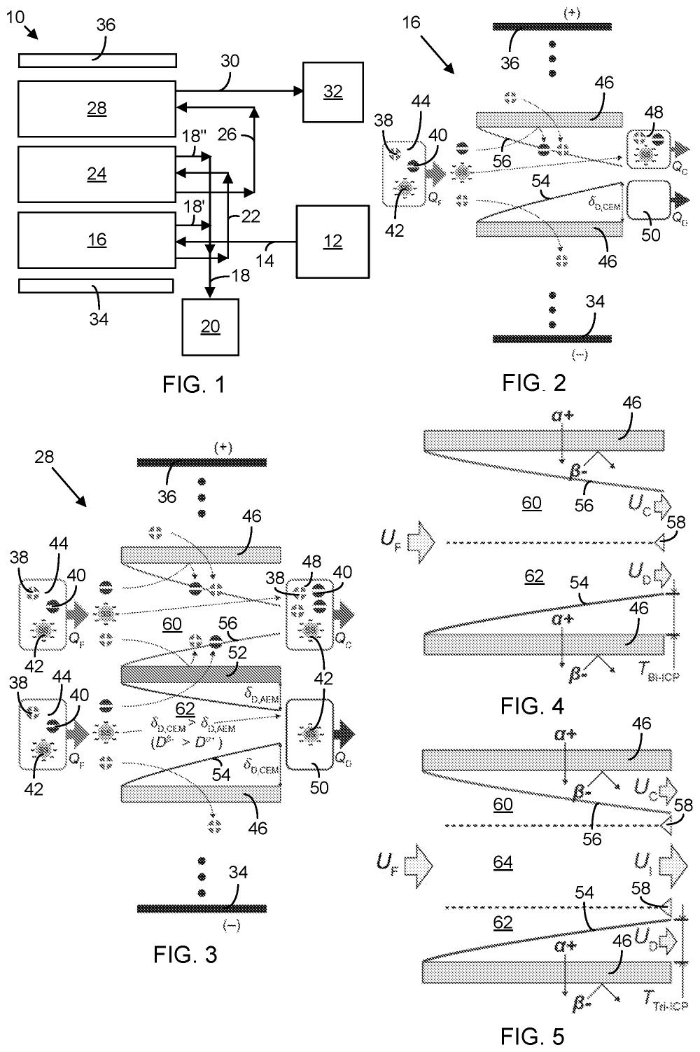

A schematic illustration of a sequentially stacked multi-stage desalination system 10 is shown in FIG. 1, wherein a reservoir 12 of an aqueous saline solution, such as seawater or brackish water (e.g., with a salinity in a range from 2.5 to 45 g/L), is coupled via a conduit 14 to an inlet port of a first-stage ion concentration polarization (ICP) device 16 (see FIG. 2) so that the aqueous solution can flow into the first-stage ICP device 16. As shown in FIG. 2, the transport of dissolved and suspended solids in an ion concentration polarization (ICP) process, includes cations 38, anions 40, and suspended solids 42 in a feed solution 44 being passed between cation-exchange membranes 46, which are sandwiched between a cathode 34 and an anode 36 to produce a concentrate stream 48 with a higher concentration of the ions and solids and a diluate stream 50 of partially purified water. The curved line 54 (at bottom) and the curved line 56 (at top) respectively indicate the depletion boundary layer and the concentration boundary layer.

This and other illustrated designs can readily be adapted for additional configurations of one or more ICP stages followed by one or more ED stages in other embodiments. In this case, the first-stage ICP device 16, shown in FIG. 2, includes an alternating stack of a cation-exchange membrane (CEM) 46 and an ICP spacer (not shown in FIG. 2 but shown as 58 in FIG. 4) between the pair of electrodes 34 and 36. The first-stage ICP device 16 further includes a diluate outlet and a brine concentrate outlet. A first branch 18′ of conduit 18 leads from the brine concentrate outlet to a brine discharge tank 20 and is configured for flow of the brine concentrate to the brine discharge tank 20. Another conduit 22 leads from the diluate outlet to an input port of a second-stage ICP device 24, which also includes a diluate outlet, which leads via another conduit 26 to an electrodialysis (ED) device 28 (see FIG. 3), and further includes a brine concentrate outlet that leads via a second branch 18″ of conduit 18 to the brine storage tank 20. The ED device 28 includes a pair of cation exchange membranes 46 and an anion exchange membrane 52. The ED device 28 further includes a diluate outlet configured to capture the diluate flow (QD) leading to conduit 30 and then to a diluate storage tank 32 for storing purified water (e.g., water that meets applicable drinking-water standards—e.g., with a salinity of less than 0.6 g/L) and a concentrate configured to capture the concentrate flow (Qc) for discharge. The first-stage ICP device 16, the second-stage ICP device 24, and the ED device 28 are stacked in sequence between a cathode 34 and an anode 36 configured to generate a charge differential across the ICP and ED devices 16, 24, and 28.

In alternative embodiments, the system 10 can include a single ICP stage 16 directly in communication with the electrodialysis device 28. In additional embodiments, multiple stages of the electrodialysis (ED) device 28 can be included in the system such that a first-stage ED device receives the diluate output of an ICP stage 16/18; and the diluate output of the electrodialysis device flows in a second-stage ED device for further purification. In still other embodiments, more than two stages of ICP and/or ED devices can be similarly linked in series in this configuration to provide the desired degree of desalination for the diluate.

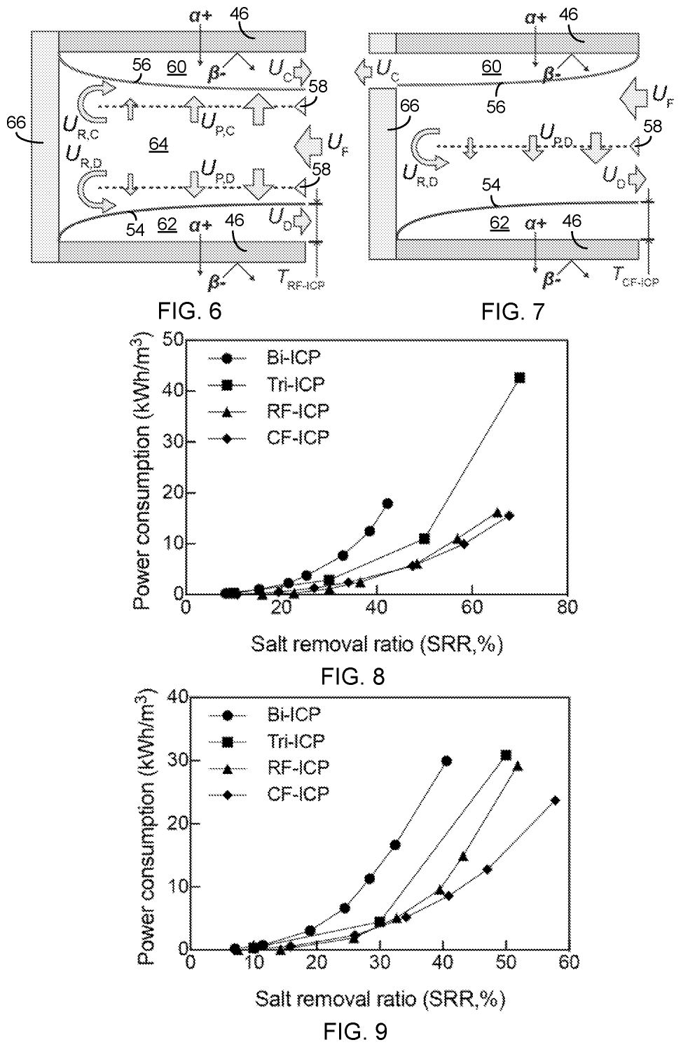

We have introduced the ICP processes with various spacers 58 and their unique features, including an ICP process with a bifurcate spacer 58 (Bi-ICP) separating a concentrate 60 above the spacer 58 and a diluate 62 below the spacer 58, as shown in FIG. 4, an ICP process with trifurcate spacers 58 (Tri-ICP) separating a concentrate 60, a diluate 62, and an intermediate liquid therebetween, as shown in FIG. 5; an ICP process with return-flow spacers 58 (RF-ICP) that separate a concentrate 60 and a diluate 62 on opposite sides of a cross-flow intermediate liquid 64, where the flow is redirected to the outside by a closed endwall 66, as shown in FIG. 6; and an ICP process with a counter-flow spacer 58 (CF-ICP), where the concentrate 60 is removed at top left through an outlet in the endwall 66, and where the diluate 62 is removed in cross-flow at the bottom right (see also Table 1, below). In each of these ICP exemplifications, the anodic side is at the top, and the cathodic side is at the bottom; and the flow velocity of the feed (U_{F}), the flow velocity of the concentrate (U_{C}), the flow velocity of the diluate (U_{D}), and the flow velocity of the intermediate stream (U_{I}) are shown with arrows.

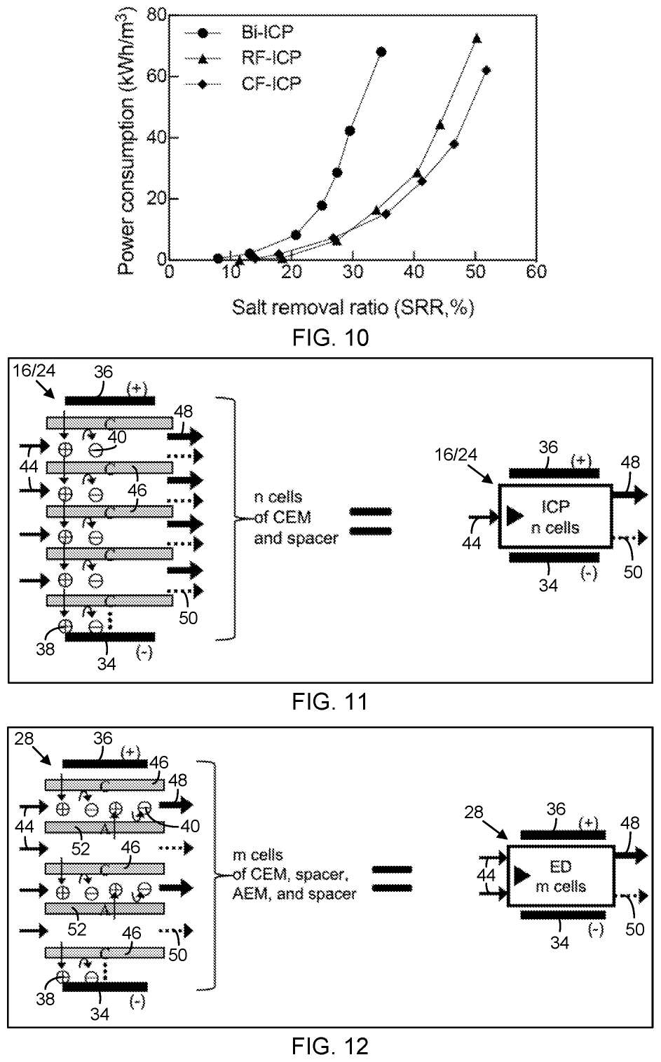

In order to evaluate the energy efficiency of different ICP process architectures (which are essentially defined by the kind of spacer design/engineering used), we obtained the power consumption as a function of the salt removal ratio (SRR) with 70, 100, and 160 g/L of feed salinity, respectively, in FIGS. 8-10. The original ICP architecture, called Bi-ICP (FIG. 4), can separate and collect two streams, diluate and concentrate (brine) streams. Bi-ICP requires the highest power consumption among the spacers, given the same conditions, because Bi-ICP simultaneously collects a stream including a thick bulk layer and a thin depletion layer. Tri-ICP (FIG. 5), which includes an intermediate-concentration liquid 64 between the concentrate 60 and the diluate 62 facilitates the collection of the thin depletion layer in the stream of the diluate 62 but suffers from a reduced recovery rate. Tri-ICP significantly improves energy efficiency compared with Bi-ICP, providing the importance of generating and collecting thin depletion layer and minimizing depletion layer thickness. The subsequently developed RF-ICP (FIG. 6), using the same channel structure as Tri-ICP, still facilitates the collection of thin depletion layers but increases the effective channel length by simply changing the flow path. This change significantly reduces power consumption again, compared to the power consumption of Tri-ICP. Another important benefit of RF-ICP is that the depletion layer across the entire membrane length is more evenly distributed, increasing the overall efficiency. The most recent implementation of CF-ICP (FIG. 7), inspired by Bi-ICP, increases the effective channel length for diluate streams but maintains the effective channel length for concentrate stream. By reversing the direction of growth of the two streams, diluate and concentrate streams, CF-ICP reduced a trans-membrane concentration difference, resulting in a reduction in back diffusion and osmosis. Therefore, it was shown (in FIGS. 8-10) that CF-ICP achieves the best power efficiency of all four architectures, given the same feedwater salinity, flow rate, and membrane length conditions.

TABLE 1
Various ICP Process Architectures:

| Type | Fluidic compartment | Feature |
|---|---|---|
| Bi-ICP | Two channels | One inlet and two outlets |
| | One porous | Separate collection of diluate |
| | membrane | and concentrate streams |
| | | Recovery rate = 50% |
| Tri-ICP | Three channels | One inlet and three outlets |
| | Two porous | Collection of thin depletion layer |
| | membranes | Recovery rate = 25% |
| RF-ICP | Three channels | One inlet and two outlets |
| | Two porous | Increase in the effective channel length |
| | membranes | Recovery rate = 50% |
| CF-ICP | Two channels | One inlet and two outlets |
| | One porous | Minimized trans-membrane |
| | membrane | concentration difference |
| | | Recovery rate = 50% |

The ED device 28, as shown in FIG. 3, includes a stack of one or more cells comprising a sequence of an anion exchange membrane 52 (AEM), a cation exchange membrane 46 (CEM), and a separator structure separating each AEM 52 from the adjacent CEM 46 to create a channel for liquid flow therebetween. The ED device 28 can include multiple AEMs 52 and CEMs 46 in alternating sequence with respective separators separating each membrane from the next membrane in sequence. The diluate from the second-stage ICP device 24 flows through channels between the membranes, wherein anions are drawn from the diluate 62 through the adjacent AEM 52 toward the anode 36 into a brine channel, while cations are drawn from the diluate 62 through the adjacent CEM 46 toward the cathode 34 into another brine/concentrate channel 60. After ions 40 are drawn out of the diluate 62 as it passes through the ED device 28, the diluate is discharged, e.g., as purified water that meets drinking water standards in terms of low salinity, to a diluate storage tank.

The schematics of ICP (FIG. 11) and ED stages (FIG. 12) with the corresponding legend are included to facilitate a better understanding of the apparatus and method.

As shown in FIG. 11, the ICP device stages 16 and 24 include a stack of cation exchange membranes 46 (CEMs) between a cathode 34 and an anode 36 with feed solution 44 streamed between the CEMs 46, with cations 38 from the feed solution 44 drawn down through the stack (in the orientation shown) to the cathode 34, while anions 40 are drawn to the top of each channel between CEMs 46, leading to a flow of concentrate solution at the top of each channel and a flow of diluate at the bottom of each channel, and those flows are respectively extracted from the ICP device 16/24 as the concentrate stream 48 and the diluate stream 50.

Meanwhile, the electrodialysis (ED) device 28 includes an alternating stack of cation exchange membranes 46 and anion exchange membranes 52 between a cathode 34 and an anode 36 with feed solution 44 streamed between the CEMs 46, with the cations 38 drawn down through the CEMs 46 and the anions 40 being drawn up through the AEMs 52 so as to concentrate cations 38 and anions 40 together in alternating channels between the membranes 46 and 52. Concentrate streams 48 and diluate streams 50 can accordingly be extracted from alternating channels in the stack.

### Sequentially Stacked ICP Stage:

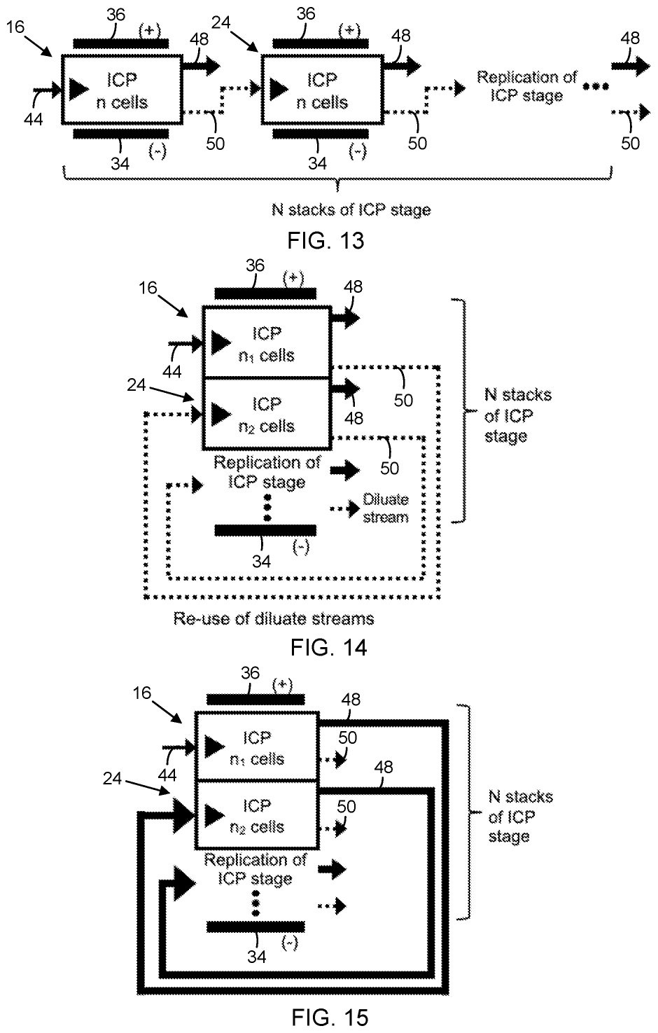

First, we elaborate on the difference between serially connected stages and sequentially stacked stages. In the case of serially connected ICP stages (as shown in FIG. 13), each ICP stage 16 and 24 has an independent pair of electrodes 34 and 36; and diluate streams are re-used for desalination application, though we do not focus here on a serial connection of ICP stages.

FIG. 14 shows sequentially stacked ICP stages 16 and 24. Each ICP stage 16/24 is sequentially stacked between a pair of electrodes 34 and 36 with the re-use of diluate streams 50 for desalination application across stages. In addition, the sequentially stacked ICP stages 16 and 24 with the re-use of concentrate stream 48 can be implemented for concentration applications (as shown in FIG. 15). n₁ and n₂ indicate cell numbers for the first ICP stage 16 and the second ICP stage 24, respectively, and N indicates a sequentially stacked stage number.

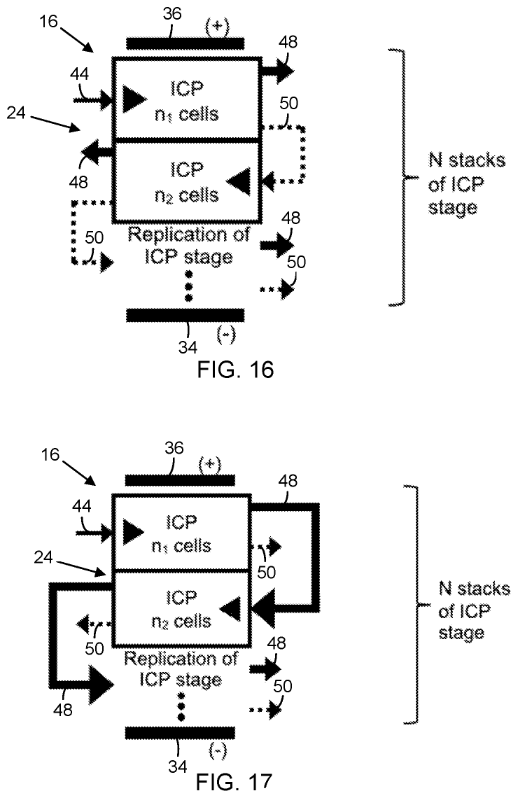

Also, the arrangement of the ICP stages 16 and 24 can be changed in terms of flow direction. In the previous schematics (shown in FIGS. 14 and 15), all ICP stages have the same flow direction, called a parallel-flow arrangement; but each ICP stage can be alternatively stacked with an opposite flow direction, called a counter-flow arrangement (as shown in FIGS. 16, which shows reuse of the diluate stream 50, and FIG. 17, which shows reuse of the concentrate stream 48).

### Sequentially Stacked ICP and ED Stages:

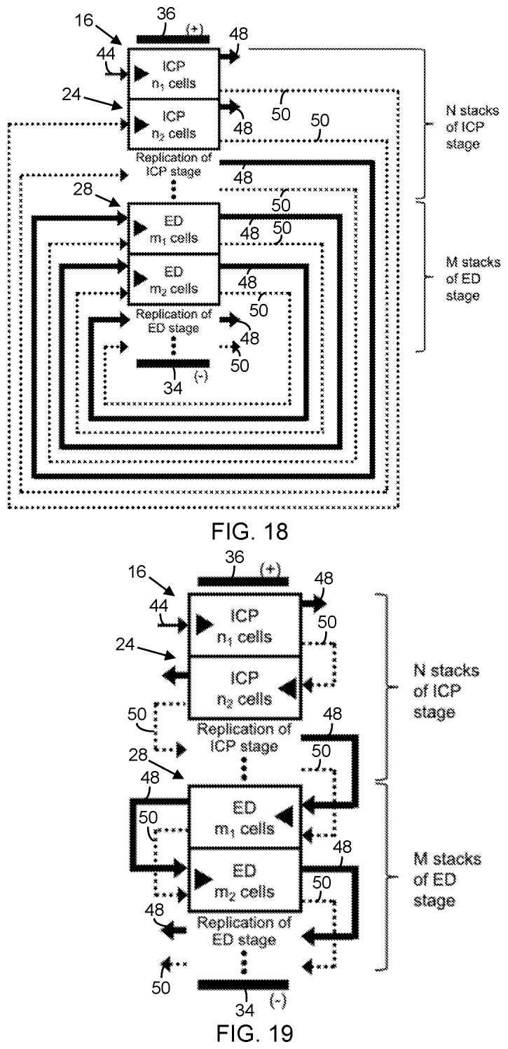

The ICP process has the advantage of high energy efficiency when performing partial desalination, but it is less energy efficient when performing complete desalination that produces drinking water compared to electrodialysis (ED). In order to maximize energy efficiency, the ICP process, which has the advantage of partial desalination, is deployed forward (i.e., upstream); and ED, which has the advantage of complete desalination, is placed in the rear (i.e., downstream), as shown in FIG. 18. The arrangement of each stage can be parallel (as in FIG. 18) or counter direction (as in FIG. 19) in terms of flow direction, both of which reuse both the concentrate and diluate streams 48 and 50 across stages.

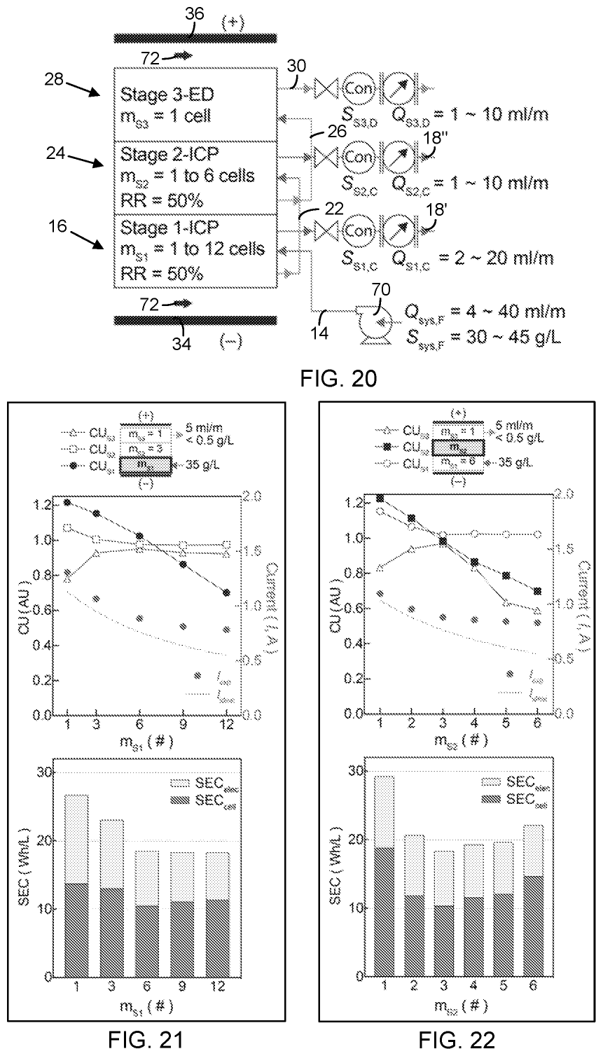

FIG. 20 shows a schematic of an experimental set-up to evaluate a process with a sequentially stacked pair of ICP stages 16 and 24 and one of ED stage 28 (2ICP/ED). Also shown is a pump 70 to deliver the feed stream through conduit 14 to the first-stage ICP device 16 as well as the flow 72 of a rinse liquid to remove ions from the electrodes 34 and 36. Three variables, the number of cells in the first ICP stage (m_{S1}), the number of cells in the second ICP stage (m_{S2}), and the flow rate of diluate stream from the system (Q_{sys,D}), are varied to find a most energy-efficient condition of 2ICP/ED for drinking water production (S_{sys,D}<0.5 g/L), as shown in Table 2, below.

TABLE 2
Conditions of Evaluation:

| Condition: | i | ii | iii |
|---|---|---|---|
| Q_{S3, D} (ml/m) | 5 | 5 | 1, 2.5, 5, 7.5, 10 |
| m_{S3} (#) | 1 | 1 | 1 |
| m_{S2} (#) | 3 | 1, 2, 3, 4, 5, 6 | 3 |
| m_{S1} (#) | 1, 3, 6, 9, 12 | 6 | 6 |

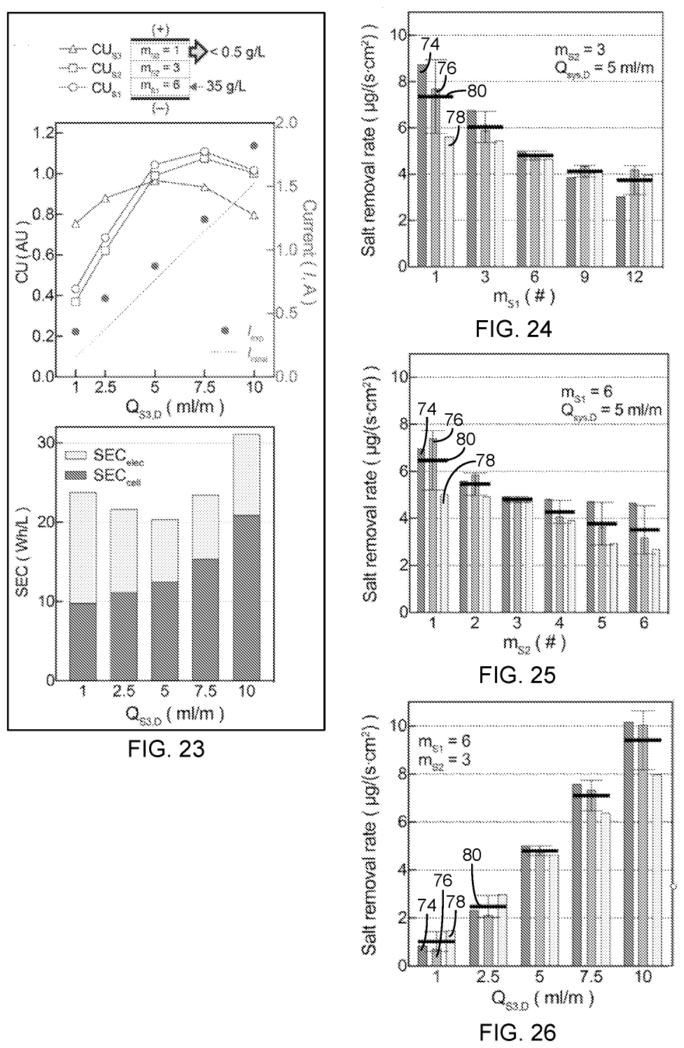

The increase in m_{S1} with m_{S2}=3 allows a larger processing area for first-stage ICP 16 with a slower flow velocity. It allows for a gradual decrease in both experimentally applied current (Iₑₓₚ) and ideal current (I_{ideal}, CU=1.2), leading to a decrease in the specific energy consumption of the electrodes (SEC_{elec}) but a significant deterioration of CUs₁ for condition i, as shown in FIG. 22. The minimized specific energy consumption of cells (SEC_{cell}=10.5 Wh/L) is observed at m_{S1}=6 when the current utilization (CU) of the three stages is at a similar level and the salt removal rate of each stage (SRRate_{S1} 74, SRRate_{S2} 76, SRRate_{S3} 78, and SRRate_{avg} 80 for the average SRRate for the three stages) is converged (see FIGS. 24 and 25). Similar phenomena are also observed in the change in m_{S2} with a more distinct valley shape in the change of SEC having the most energy-efficient condition at m_{S2}=3 (see FIG. 23). These two experimental sets provide the most energy-efficient cell number (m_{S1}=6 and m_{S2}=3) in the 2ICP/ED process. The optimized cell numbers are implemented to evaluate the diluate flow rate of the third-stage ED device (Q_{S3,D}). SEC_{cell} increases as Q_{sys,D} increases, but SEC decreases with a significant reduction in SEC_{elec} until Q_{sys,D} reaches 5 ml/m. The salt removal rates converge with the smallest standard deviation at the condition of Q_{sys,D}=5 ml/m (FIG. 26). After that, the growth of CU begins to decrease; and, especially, the CU of the third stage (ED) starts to decline with an increase in SEC.

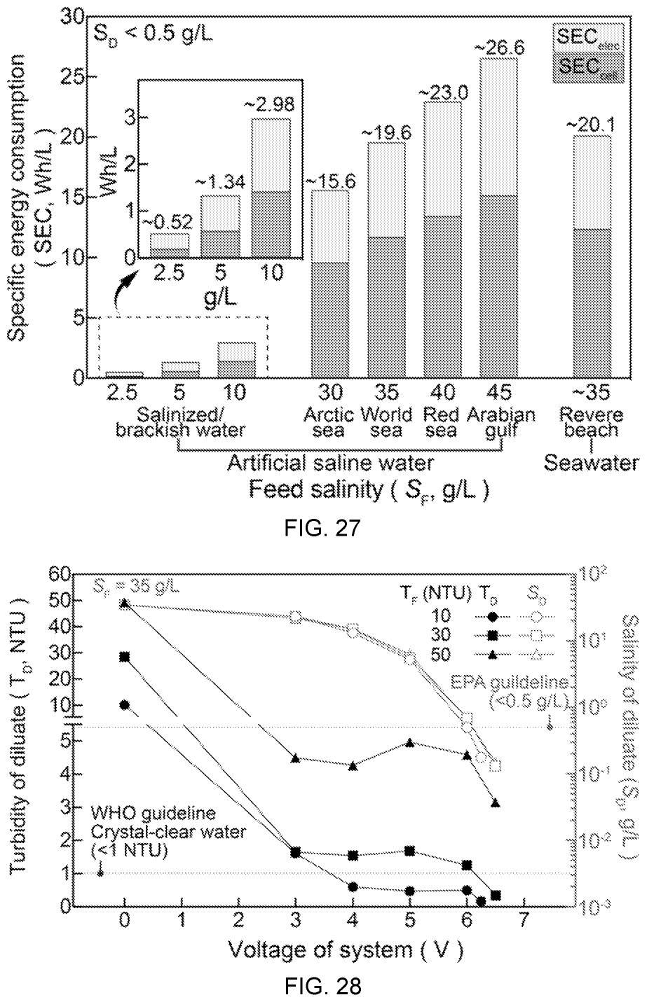

The performance of 2ICP/ED with the optimized conditions (m_{S1}=6, m_{S2}=3, m_{S3}=1, and Q_{S3,D}=5 ml/m) is experimentally evaluated in terms of total dissolved solids (TDS) removal, total suspended solids (TSS) removal, scalability of production rate, and long-term operability (see FIGS. 27-30).

Firstly, the TDS removal capacity is evaluated with two saline water groups, brackish water (2.5, 5 and 10 g/L of salinity) and seawater (30, 35, 40 and 45 g/L of salinity), to represent saline waters in various locations (see FIG. 27). For brackish water desalination (2.5˜10 g/L), 0.52˜2.98 Wh/L of SEC is required to produce drinking water (<0.5 g/L), comparable to electrodialysis (ED), where 0.4˜4 Wh/L of SEC is used to treat 2˜ 10 g/L of feed salinity. An advantage of 2ICP/ED is that the diluate stream is continuously produced with a smaller effective membrane area (15×5 cm²) than has been possible in batch-operated ED with bench-top scale (1.01 Wh/L, from 2.9 to 0.16 g/L with 64 cm²) or continuous-operated ED with an industrial-scale system (0.91 Wh/L, 3.4 to 0.46 g/L with 3,310 cm²). For seawater desalination, 2ICP/ED requires a relatively high SEC (15.6˜26.6 Wh/L, from 30˜45 g/L to <0.5 g/L) compared to ED, which requires 3.3˜ 8.5 Wh/L of SEC. However, ED utilizes an industrial-scale membrane size for a single-stage operation (e.g., 200×14 cm² of effective area, 8.5 Wh/L, from seawater to <0.4 g/L) or a bench-top scale membrane size with a multi-stage operation (e.g., 3-stage ED with 100 cm² of effective area per stage, 3.3 Wh/L, 27 g/L to 1.9 g/L). In summary, 2ICP/ED successfully produces drinking water (i.e., with a salinity <0.5 g/L) from a wide range of feed salinities (2.5˜ 45 g/L). The SEC of 2ICP/ED linearly increases with an increase in feed salinity because higher electric current is required to produce drinking water from higher feed salinity. In particular, the difference between the actually applied and the theoretically required currents increases as a feed salinity increases because the perm-selectivity of ion exchange membrane deteriorates with higher salinity. resulting in additional energy input.

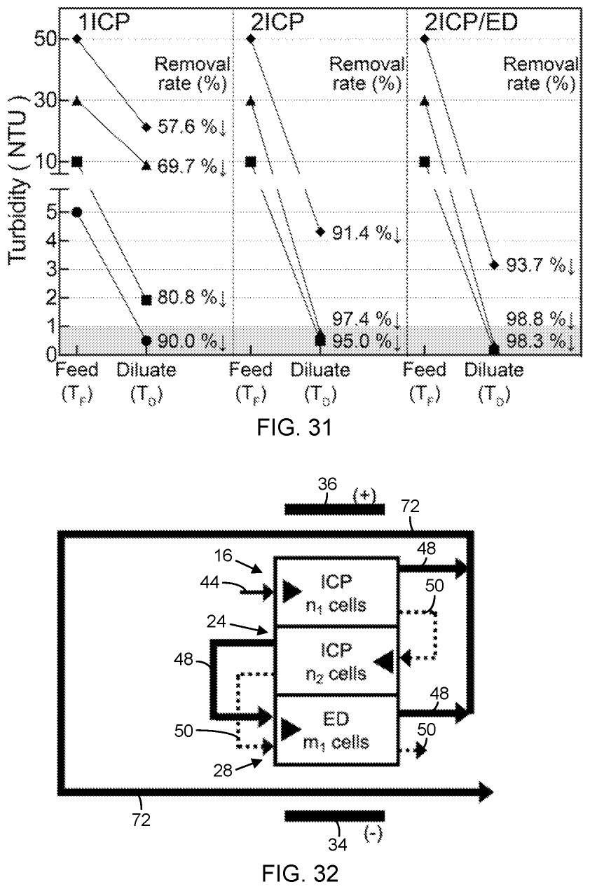

Secondly, the feasibility of TSS removal is evaluated with 10, 30 and 50 NTU of turbidity in 35 g/L of TDS solution to represent normal seawater (˜5 NTU) and seawater made cloudy by tide (˜35 NTU) (see FIGS. 28 and 31). In 2ICP/ED, TSS is removed through two consecutive ICP stages. The use of one ICP stage allows one to achieve crystal-clear water (<1 NTU) from the water with not more than 5 NTU of turbidity, but a feed with over 5 NTU of turbidity (e.g., 10 and 30 NTU of turbidity) utilizes two ICP stages to reduce the turbidity less than 1 NTU. However, the turbidity of more than 30 NTU (i.e., 50 NTU) was not lowered to the desired level by two ICP stages; and this higher TSS may cause a fouling issue of TSS sticking to the AEM in the third-stage ED (2ICP/ED reduced more TSS, compared with one ICP stage and two ICP stages; see FIG. 31). In summary, it shows that the two-ICP process in 2ICP/ED enables removal of suspended solids up to 30 NTU to produce crystal-clear water (<1 NTU) and prevention of possible fouling by suspended solids on the AEM in the third-stage ED device. At the same time (i.e., concurrently in a single run and without requiring additional energy consumption for pretreatment), the TDS is also reduced to a drinkable level.

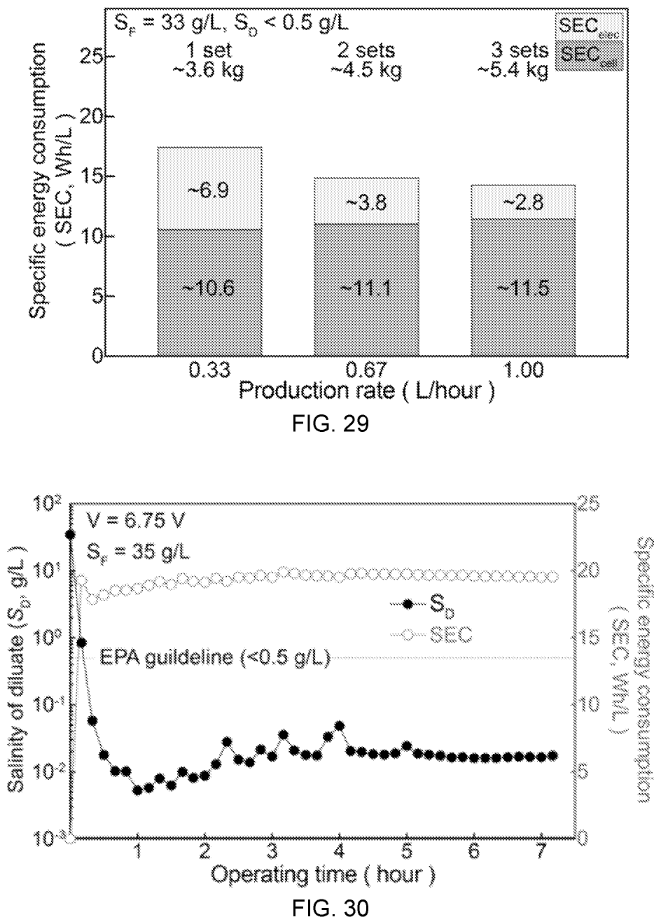

Thirdly, we evaluate the scalability of 2ICP/ED in production rate by increasing the number of stacked cell sets by 2-3 times in terms of SEC (see FIG. 29, which plots SEC as a function of production rate for, from left-to-right, one set of cells, two sets of cells, and three sets of cells); details on the number of cells are in Table 3, below). As the number of cells and the production rate increase, the power consumption linearly increases from 5.8 to 14.3 W, but the energy efficiency improves from 17.5 to 14.3 Wh/L with a near constant SEC_{cell} (10.5˜11.5 Wh/L) and an improved SEC_{elec} from 6.9 to 2.8 Wh/L. As the number of cells and the production rate increases, the power consumption linearly increases from 5.8 to 14.3 W, but the energy efficiency improves from 17.5 to 14.3 Wh/L with a decrease in SEC_{elec} from 6.9 to 2.8 Wh/L. This relationship occurs because the power consumption by the electrodes remains the same (2.3˜2.8 W) regardless of the number of cells between electrodes; but the production rate determining the SEC increases, leading to the reduction of SEC_{elec}. The size (from 7.7 to 13.6 cm-thickness) and weight (3.6 to 5.4 kg) of 2ICP/ED module increase linearly as the number of sets increases (from one to three sets).

TABLE 3
The Number of Sets of Cells to Evaluate
Scalability of Production Rate:

| Number of sets | 1 set | | 2 sets | | 3 sets | |
|---|---|---|---|---|---|---|
| mₛ₁ | 6 | | 12 | | 18 | |
| mₛ₂ | 3 | | 6 | | 9 | |
| mₛ₃ | 1 | | 2 | | 3 | |
| Q_{sys, D} | 0.33 | L/h | 0.67 | L/h | 1.00 | L/h |
| Weight | ~3.6 | kg | ~4.5 | kg | ~5.4 | kg |

| | | | |
|---|---|---|---|
| Size | 31 cm × 15 | 31 cm × 15 | 31 cm × 15 |
| (Length × Width × | cm × 7.7 cm | cm × 10.7 cm | cm × 13.6 cm |
| Thickness) | | | |

Lastly, the long-term operation of the system is evaluated (FIG. 30). After onset of application of constant voltage (6.75 V), the salinity of the diluate stream continuously drops, and then it reaches the level of drinking water (<0.5 g/L) after ˜10 minutes. As shown in FIG. 30, the salinity of the diluate stream, S_{D} (plotted with solid circles) and the specific energy consumption (SEC) (plotted with empty circles) show substantially constant values, indicating that the system operates reliably with no apparent deterioration in energy efficiency at least for 7 hours, without the need for polarity reversal to mitigate fouling.

### Re-Use of Concentrate Stream as Rinse Flow

The concentrate streams 48 can be re-used for electrode rinse flow 72 to clean the anode 36 and the cathode 34, as shown in FIG. 32. In this exemplification, the diluate and concentrate streams 50 and 48 are also reused across stages. In particular exemplifications, a concentrate stream 48 can be recycled to first rinse the anode 36 or cathode 34 and then to rinse the other electrode 34/36.

### Assembled System:

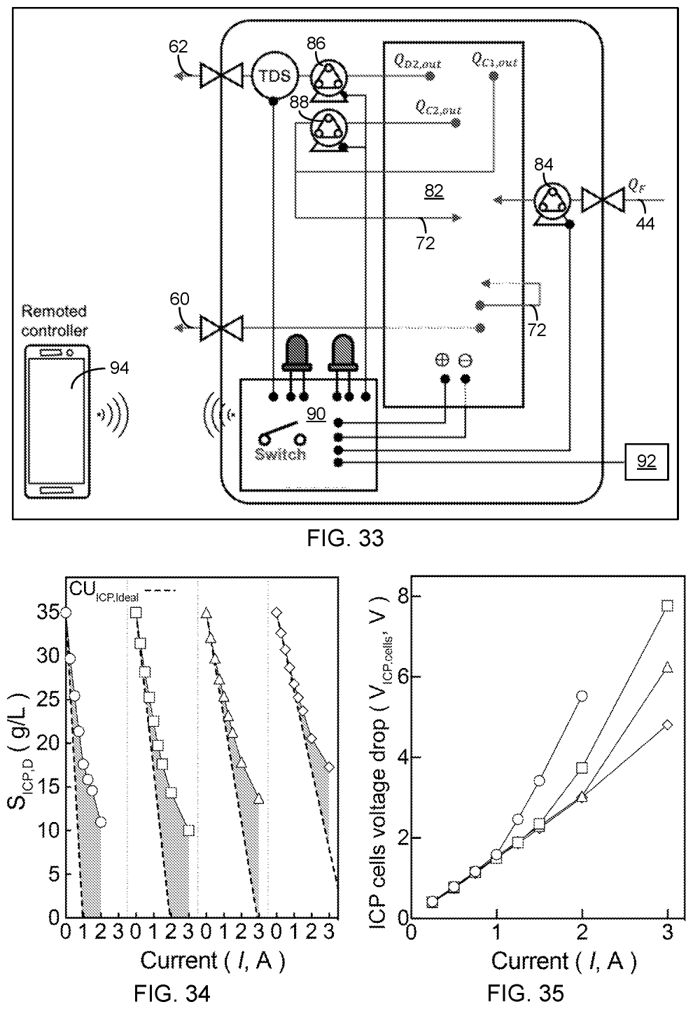

FIG. 33 is a schematic illustration of an assembled desalination unit and a remote controller. The assembled desalination unit includes a sequentially stacked ICP and ED stages module 82 (in this case, 2ICP/ED) with re-used concentrate streams (Q_{C1,out} and Q_{C2,out}) as rinse flow 72, one pump 84 for feed flow 44 (Q_{F}), two pumps 86 and 88 for diluate and concentrate streams (Q_{D2,out} and Q_{C2,out}) from the module 82, total dissolved solids (TSS) sensor, and an internal controller 90 connected with an external power source 92. The (internal) controller 90 can communicate (e.g., wirelessly) with a remote controller 94 for controlling operation of the system. The remote controller 94 can be a smartphone. The use of two pumps for the outlets allows one to control the flow rate at the outlets.

### Experimental Characterization of Unit Processes ICP and ED:

Initially, we began by experimentally characterizing the unit processes (ICP and ED) over a range of operating parameters to build a predictive engineering model. The ICP and ED cell sizes were fixed (150×50 cm²) to ensure the system's portability. To evaluate the ion removal efficiency, the current utilization (CU) and salt removal ratio (SRR) are obtained as follows:

$$\\ CU = \frac{{zFQ}_{D} ( {S}_{F} - {S}_{D} )}{mI} , and SRR ( \% ) = \frac{( {S}_{F} - {S}_{D} )}{{S}_{F}} \times 100 \% ,$$

where S_{F} and S_{D} are salinities of feed and diluate streams, respectively. z is ion valence, and z=1 is assumed for seawater because the majority of ionic components is NaCl. F indicates Faraday's constant (=9.65×10⁴ C/mol). m and I are cell numbers and current, respectively. The flow rates of diluate (Q_{ICP,D} and Q_{ED,D}) and concentrate (Q_{ICP,C} and Q_{ED,C}) streams in the ICP and ED devices 16, 24, and 28 are controlled so that the unit stage recovery rate is 50%.

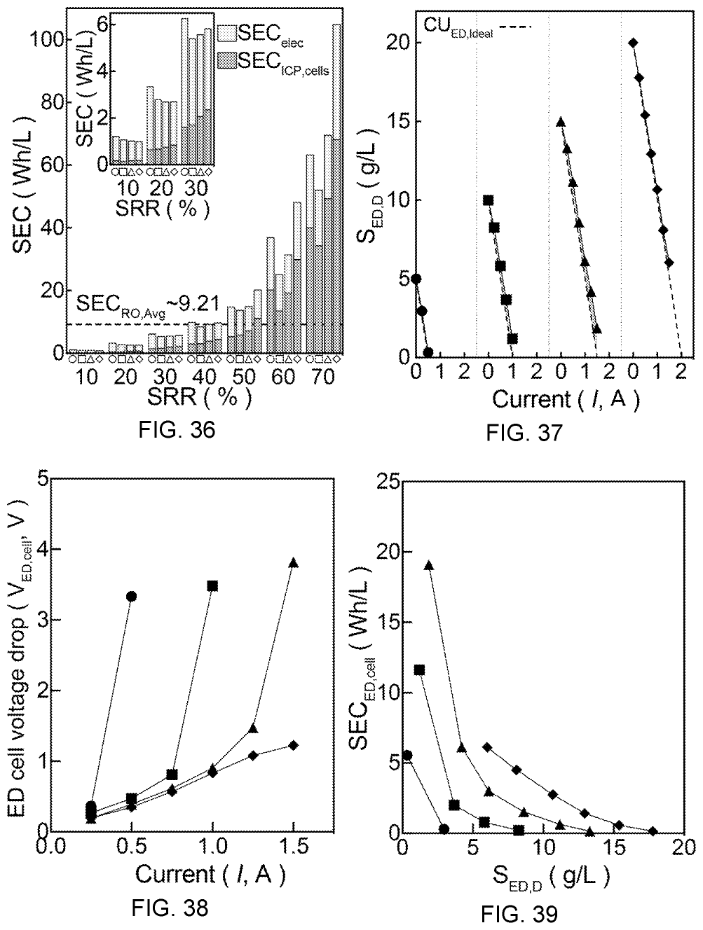

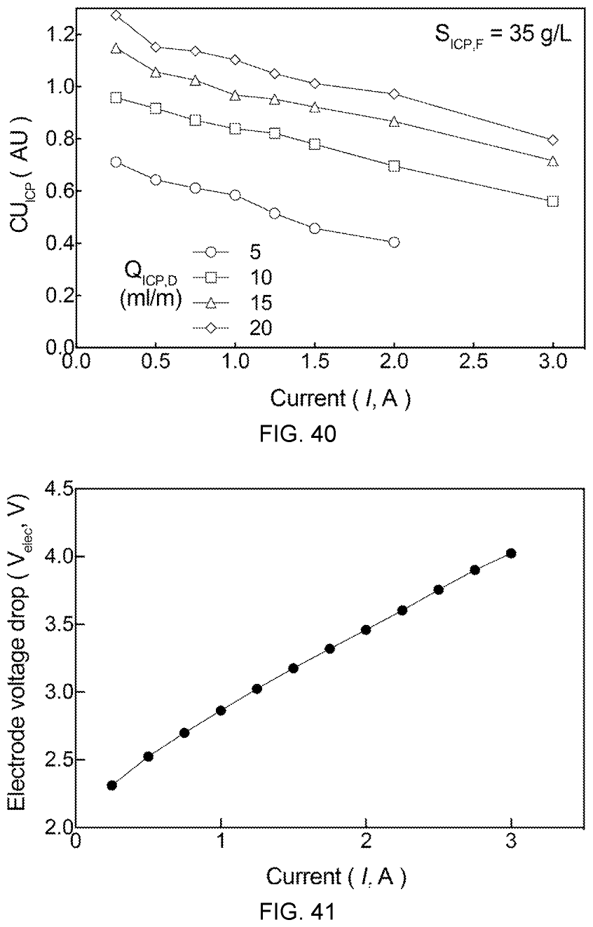

FIGS. 34-36 illustrate the results of an experimental system for single-stage ICP, with the plots of FIGS. 34 and 35 reflecting diluate flow rates (Q_{ICP,D}) of 5 ml/m (circles), 10 ml/m (squares), 15 ml/m (triangles), and 20 ml/mm (diamonds). Artificial seawater (S_{ICP,F}=35 g/L) is applied at various feed flow rates (Q_{ICP,F}) and current (I) conditions in the ICP process. Higher diluate flow rates (Q_{ICP,D}) requires more current to achieve a similar desalted stream in the ICP process (S_{ICP,D}, FIG. 34) but results in improved current utilization of the ICP stage (CU_{ICP}, FIG. 40). On the other hand, lowering Q_{ICP,D} allows the system to operate with a lower current but deteriorates salt-removal performance (gray shaded area in FIG. 34). Low flow (Q_{ICP,D}) and low current operation may lower the energy loss incurred at the electrodes (lower V_{elec}, FIG. 41) but may also induce an increased cell voltage drop (V_{cell}) due to operating beyond an ohmic regime where unwanted physicochemical phenomena appear, which will be discussed in the following section. In order to capture all of these trade-offs, we independently evaluated the specific energy consumption of cells (SEC_{cell}), electrodes (SEC_{elec}), and the system (SEC_{sys}) as follows:

$$\\ {SEC}_{ICP , cells} = \frac{{mV}_{ICP , cells} \times I}{{Q}_{D}} , {SEC}_{elec} = \frac{{V}_{elec} \times I}{{Q}_{D}} , and$$

$$\\ {SEC}_{sys} = {SEC}_{ICP , cells} + {SEC}_{elec} .$$

From the experimental results, one can see that higher Q_{ICP,D} lowers both SEC_{ICP,cells} and SEC_{elec}, until the target salt removal ratio (SRR) reaches up to 20%. When the target SRR is set higher, both SECs values surge in a nonlinear manner, rendering the process inefficient. The minimized SEC can be found at the 10 ml/m of Q_{ICP,D}.

We also experimentally characterized the single-stage ED device, where diluted artificial seawater at different TDS level (S_{ED,F}=5˜20 g/L) was desalinated at the defined product flow rate (Q_{ED,D}=5 ml/m). The output salinity of the ED stage (S_{ED,D}) decreases as we increase the current with a near ideal CU (CU_{ED,ideal}, FIG. 37). The ED cell voltage drop (V_{ED,cell}, FIG. 38), however, dramatically increases resulting in higher SEC (SEC_{ED,cell}, FIG. 39) when the output salinity becomes lower (closer to drinkable water level). The plots of FIGS. 37-39 reflect salinities of the feed to the ED device (S_{ED,F}) of 5 g/L (circles), 10 g/L (squares), 15 g/L (triangles), and 20 g/L (diamonds).

These results show the unique advantages and disadvantages of ICP and ED processes. As previously demonstrated, ICP is ideally suited for partial desalination from high salinity feedwater due to its higher CU values in general. However, single-stage ICP fails to produce drinking water from seawater with competitive SEC values, far exceeding the average SEC of commercialized RO (SEC_{RO,avg}˜ 9.21 Wh/L). This is because of the lowering of the CU value (gray area in FIG. 34), which is presumably caused by intra-cell mixing between diluate and concentrate streams. Therefore, a final stage ED is used to remove remaining salts.

### Optimization of Multi-Stage Desalination System:

The multi-stage process is applied in desalination to avoid large entropy generation and significant thermal disequilibrium in a single-stage process. In particular, entropy generation (and excessive energy consumption) in electromembrane processes (ED and ICP) increases in a nonlinear fashion with current, due to new current carrier generation, membrane discharging by thicker depletion layer, trans-membrane concentration difference leading to osmosis and diffusion, and electro-osmosis. It is, therefore, challenging to optimize the staging configuration toward the ideal trade-off between productivity (needed for a small-size membrane) and energy efficiency (needed for a small-size battery) without engineering models for unit processes. Several physics-based models, solving Nernst-Planck-Poisson and Navier-Stokes equations concurrently, have already been developed to describe ion transport mechanisms of a conventional electromembrane process (i.e., ED); but they are limited to operating in an ohmic regime where voltage drop and ion transport respond linearly with changes in current. Also, simulation-based surrogate models based on machine learning methods were applied to predict ED processes, treating brackish water (2˜10 mM of salt) for which ion-exchange membranes could retain their ideal permselectivities. However, these earlier models for electromembrane process are not adequate for our purpose, where small-size electromembranes push the operating current beyond the ohmic regime.

We implemented machine learning methods to predict the nonlinear characteristics (i.e., SRR and energy efficiency) of electromembrane processes (ICP and ED) in multistage configuration for seawater desalination. The predictive models are trained based on the experimental results of single-stage ED and ICP. The current (I=1˜3 A), feed salinity (S_{ICP,F}=15˜ 45 g/L and S_{ED,F}=5˜ 20 g/L), feed flow rate (Q_{ICP,F}=5˜ 30 ml/m and Q_{ED,F}=5˜ 10 ml/m), and cell number (m_{ICP}=6 and m_{ED}=1) are used as input variables to predict the cell voltage drop (V_{cell}) and the salinity of the diluate stream (S_{D}) in ICP and ED as output variables. Then, the overall performance of a proposed multistage configuration was predicted for the conversion of seawater salinity (S_{sys,F}=35 g/L) into drinking water salinity (in this case, S_{sys,D}˜0.5 g/L) with a given set of membrane size and product flow rate (Q_{ED,D}). By assessing the performance of various multistage configurations, the model can reveal general guidelines for optimal ICP/ED staging configurations. For example, as the number of stages increases, the power consumption generally increases by redistributing the desalination burden; but the recovery rate deteriorates significantly. At least one ED stage should be included at the final stage for energy-efficient complete desalination. A multistage process is most energy-efficient when the desalination burden is evenly distributed among different stages. Guided by the model, we determined the most optimal multistage configuration to be the sequence of two ICP stages and single-stage ED, operating between a set of common electrodes (2ICP/ED). The operating conditions to achieve 110% of minimum energy per ion removal are observed in the range of the number of cells for the first stages (m_{S1}, where 6<m_{S1}<16) and the second stage (m_{S2}, where 2<m_{S2}<6), and 5 ml/m of final diluate flow rate (Q_{sys,D}).

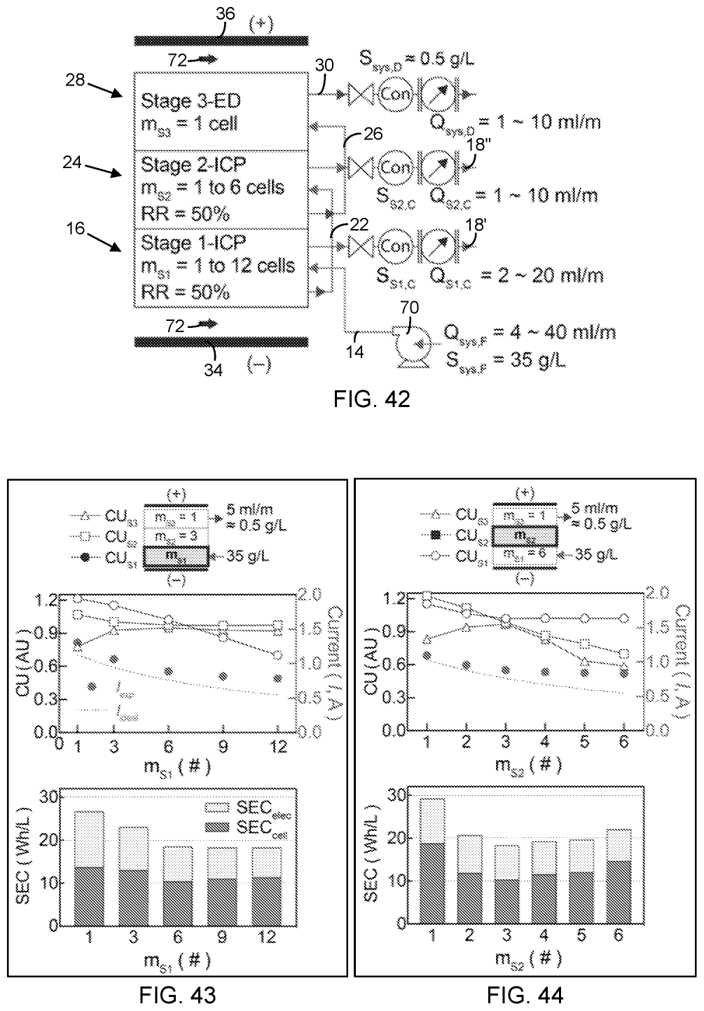

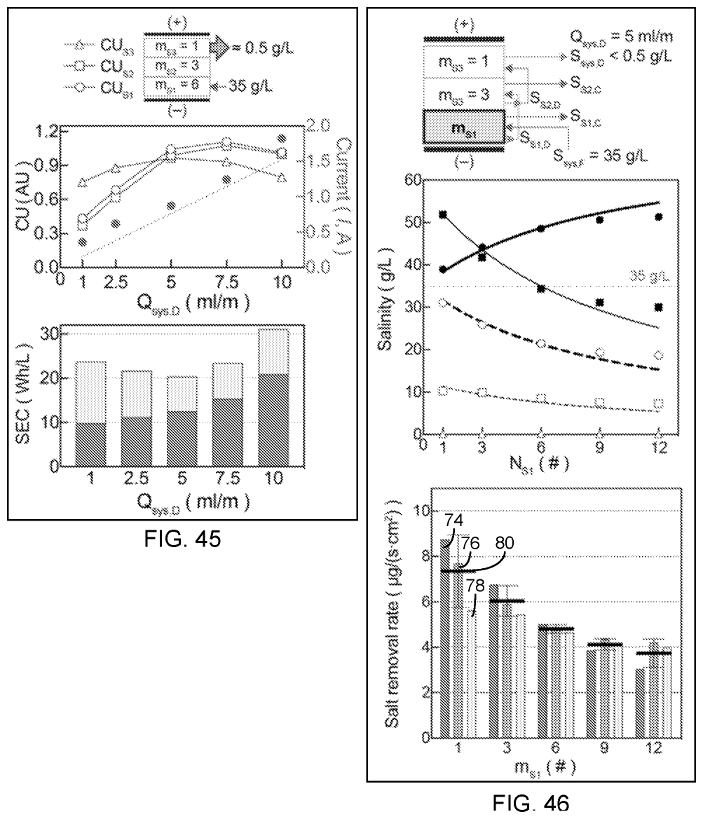

We experimentally validated the multi-stage process (2ICP/ED) configuration and operating conditions optimized by the model. FIGS. 42-45 show schematic illustrations of the experimental set-up of the multi-stage system and the results of experiments performed with that system, including plots of the current utilization (CU) in the first ICP stage (plotted as hollow circles), in the second ICP stage (plotted with hollow squares) and from the third (ED) stage (plotted with hollow triangles), as well as current plots (as solid circles). The specific energy consumption (SEC) plots in FIGS. 43-45 include the SEC of the electrodes (SEC_{elec}) in dark at the bottom of the plot and the SEC of the cells (SEC_{elec}) as a lighter plot atop the SEC_{elec} plots for various numbers of cells, m (along the horizontal axis), in each stage.

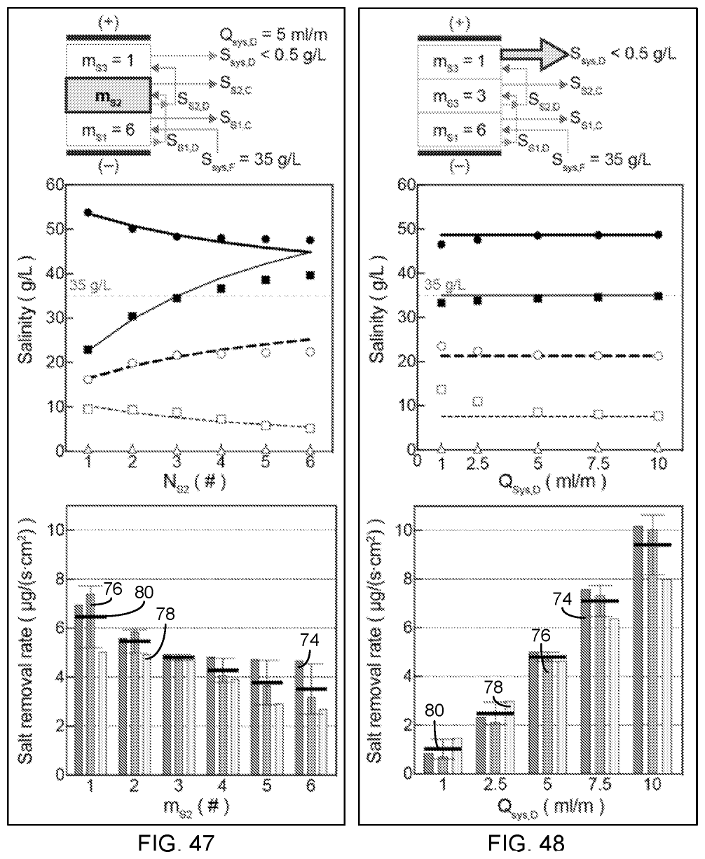

There are only three independent variables, m_{S1}, m_{S2}, and Q_{sys,D}, to be controlled for the most energy-efficient condition of 2ICP/ED for drinkable water production (S_{sys,D}<0.5 g/L). For example, in FIG. 43, a higher m_{S1} with fixed m_{S2} (=3) allows a progressively larger processing area for the first-stage ICP with a slower flow velocity. Therefore, one can decrease the applied current (Iₑₓₚ), leading to a decrease in SEC_{elec}. However, this will deteriorate the first-stage current utilization, CU_{S1} (as seen by the departure from the value predicted assuming an ideal CU value), because more desalination burden is reallocated to the first-stage ICP 16. The minimized SEC_{cell} (=10.5 Wh/L) is observed at m_{S1}=6 when CU and the salt removal rate of each stage become similar (FIGS. 46 and 47). m_{S2} can also be optimized similarly, with the most energy-efficient condition being at m_{S2}=3 (see FIG. 44). These two sets of experiments determined the most energy-efficient cell number (m_{S1}=6 and m_{S2}=3) in the first and second ICP stages of the 2ICP/ED configuration, with a given Q_{sys,D}. Experimental results with various Q_{sys,D} values also confirm that SEC decreases with a significant reduction in SEC_{elec} until Q_{sys,D} reaches 5 ml/m, which is the optimal operating conditions.

At Q_{sys,D}=5 ml/m, as shown in FIGS. 46 and 47, one can also observe that the salt removal rate per membrane area is similar for all three stages, suggesting that the desalination burden is equally distributed at this condition (FIG. 48). The solid plots in the salinity charts of FIGS. 46-48 represent the salinity of the concentrate from stage 1 (S_{S1,C}) as circles and the salinity of the concentrate from stage 2 (S_{S2,C}) as squares; meanwhile, the salinity of the diluate from stage 1 (S_{S1,D}) is shown as hollow circles; salinity of the diluate from stage 2 (S_{S2,D}) is shown as hollow squares; and the salinity of the diluate from stage 3 (S_{sys,D}) is shown as hollow triangles. In the chart with the salt removal rates in FIGS. 46-48, the following respective salt removal rates are plotted, as in FIGS. 24-26: SRRates₁ 74, SRRates₂ 76, SRRates₁ 78, and SRRate_{avg} 80.

### Pump-Free, Gravity-Fed Desalination:

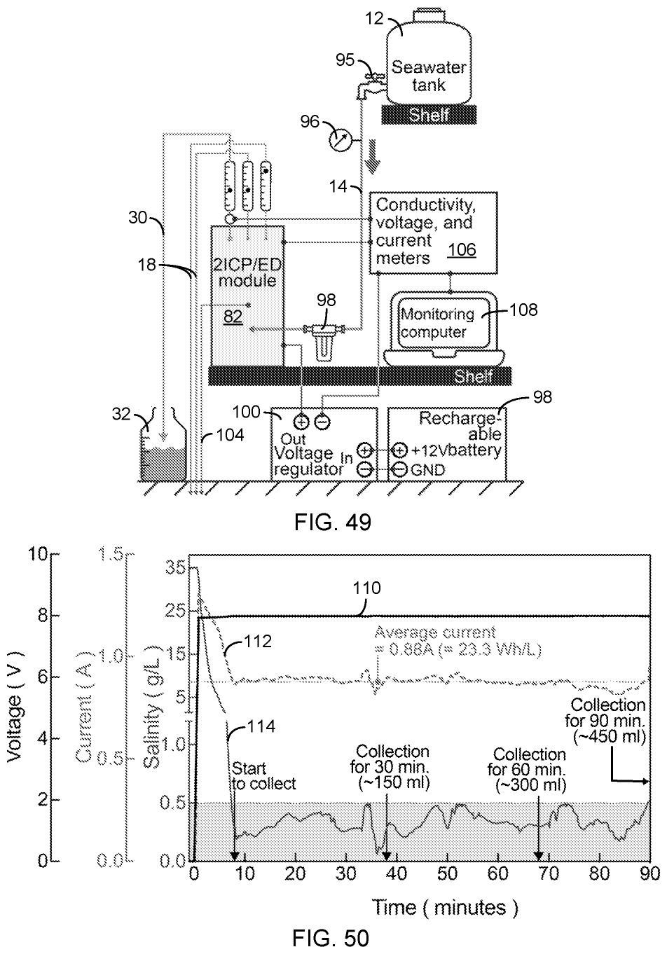

The electromembrane desalination process enjoys low hydraulic resistance and can be operated by gravity-fed flow. Such a low-pressure pumping requirement is ideal for an off-grid, resource-limited environment. The feasibility of the gravity-fed operation was previously evaluated for the desalination of brackish water (˜5 g/L) in ED but not for the desalination of seawater. A schematic illustration of a 2ICP/ED system operated by gravity-fed flow for seawater desalination is provided in FIG. 49. As shown therein, a feed reservoir 12 in the form of a 40-L tank filled with artificial seawater (˜ 35 g/L) and configured with an output flow-control valve 95 is placed 1 meter above the 2ICP/ED module 82 with which it is in fluid communication via a conduit 14 configured with a pressure gauge 96 for measuring the pressure therein and with a 5-μm-pore filter 97 for filtering solids from the feed liquid. The gravity-fed flow of the feed liquid through the conduit 14 is shown with the arrow. The reservoir 12 is periodically filled with artificial seawater to maintain a water level of 1.5 meters. The hydrostatic pressure of 1.5 meters of water (˜14.67 kPa) is large enough to allow fluid flow through the system because the hydraulic pressure drop through the system (˜ 0.14 kPa) is much smaller. At the same time, the ICP module was powered by a solar-panel-rechargeable battery 98 fed through a voltage regulator 100 to evaluate the feasibility of the off-grid operation.

The conduits 18 for the flow (Q_{Cs}) of the concentrate streams and the conduit 30 for the flow (Q_{sys,D}) of the diluate stream from the ED device are configured with flow controllers 102 for controlling the flow therethrough. An electrode rinse solution is also withdrawn from the 2 ICP/ED module 82 via a rinse conduit 104. The diluate stream from the ED device is collected from the conduit 30 in a purified-water storage tank 32 for subsequent use. Further, conductivity, voltage and current meters 106 are configured to measure these properties in the liquids in the diluate conduit 30 and inside the 2ICP/ED module 82, while also being in electronic communication with a monitoring computer 108 for storing and analyzing this data.

FIG. 50 shows the results of an experimental run for 90 minutes, including the voltage 110, current 112, and salinity 114 for the diluate output. The salinity of the diluate stream of the system successfully decreases below the drinking water level (<0.5 g/L). In addition, the salinity fluctuated non-periodically because the bubble generation on electrodes changes the hydraulic resistance, generating flow fluctuation. Notably, the fluctuations in salinity and current show a similar trend because the electrical resistance of the system mainly depends on the third stage (ED), where highly desalted water is processed (e.g., the resistivities of 35 and 0.25 g/L of NaCl are 0.18 and 19.4Ω·m, respectively, at 18° C.). Still, this demonstrates the pump-free seawater desalination ideal for extremely power-challenged situations, with an energy consumption of 23.3 Wh/L, for generating a reasonable amount of water for many applications.

### Field Testing of Sequentially Stacked Multi-Stage Desalination Unit:

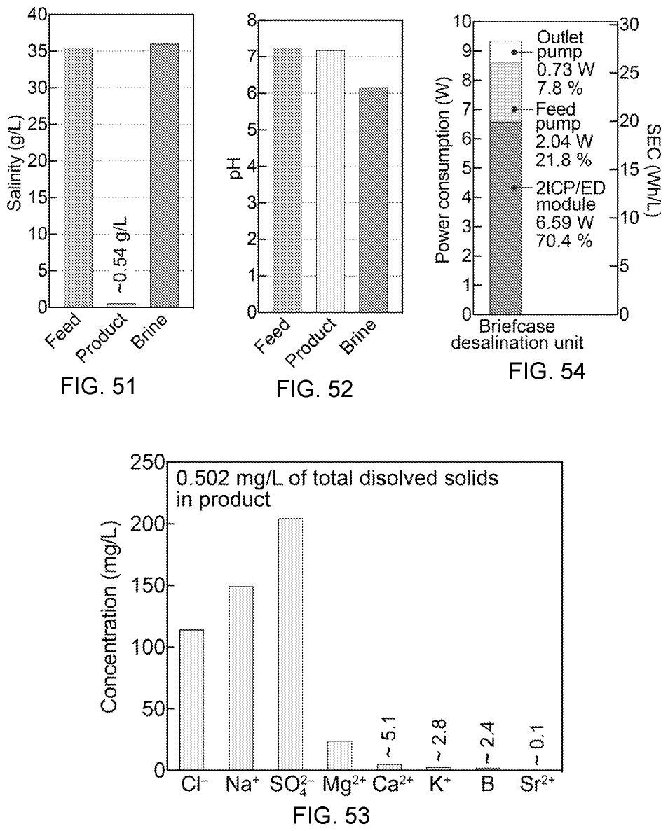

A fully automated portable desalination unit was tested on a beach (Carson Beach, Massachusetts, USA) for on-site seawater desalination using natural, unprocessed seawater. The components, the 2ICP/ED module, two pumps, a customized automated controller, and a battery, were assembled in a hard briefcase with 42×33.5×19 cm³. The total weight of the desalination unit was 9.4 kg, inclusive of the battery. A smartphone wis in wireless communication with the desalination unit, wherein the smartphone stored a software application that was developed to control the unit wirelessly and receive critical data on the power consumption (by pumps and 2ICP/ED module) and the salinity of product water in real-time. The unit was turned on by pressing a power button on the desalination unit and starting the initializing phase. Then, the desalting phase is initiated by pressing the start button on the unit or the smartphone. During the desalting phase, the controller automatically runs the flushing process to remove residual liquids and air bubbles from the 2ICP/ED module. After that, voltage is applied to the 2ICP/ED module, with a corresponding sign, “Processing . . . ,” displayed on a status screen on the unit. Once the salinity reaches the drinkable water level (<0.6 g/L), the controller notifies the message, “Drinking,” on the screen and smartphone. FIGS. 51 and 52 show that the unit successfully produced drinking water (˜0.54 g/L, ˜0.4 NTU, pH 7.25) by directly feeding natural seawater (˜35.5 g/L, ˜7 NTU, and pH 7.18).

The concentrations of Cl⁻, Na⁺, and SO₄²⁻ in the product water (as shown in FIG. 53) were ˜114, ˜150, and ˜205 mg/L, respectively, which is lower than taste thresholds according to the WHO guidelines for drinking-water quality. The boron (B) concentration in the product water (˜2.4 mg/L) was kept equal to the concentration in the feed seawater (˜2.4 mg/L, see Table 4, below).

TABLE 4
composition of feed, brine, and product water:

| | | Feed | | |
|---|---|---|---|---|
| | Standard | (Seawater from | | |
| Solute | seawater* | Carson Beach) | Brine | Product water |
| Cl | 19261.9 | 19228.0 | 19606.0 | 114.2 |
| Na | 10730.9 | 10027.5 | 10237.5 | 149.5 |
| S | 2699.6 | 2704.3 | 2834.3 | 204.5 |
| Mg | 1277.7 | 1137.0 | 1155.8 | 24.1 |
| Ca | 410.2 | 369.6 | 392.9 | 5.1 |
| K | 397.2 | 678.7 | 688.8 | 2.8 |
| B | 27.3 | 2.7 | 2.7 | 2.4 |
| Sr | 7.9 | 3.8 | 4.0 | 0.1 |
| Sum | 34812.6 | 34151.6 | 34921.9 | 502.7 |

*As specified in Millero, Frank J., et al., “The composition of Standard Seawater and the definition of the Reference-Composition Salinity Scale,” Deep Sea Research Part I: Oceanographic Research Papers 55.1, 50-72 (2008).

Although the level of boron concentration in the product water barely meets the drinking water standards (2.4 mg/L of boron), doing so may depend on the level of boron concentration in the feed seawater because boric acid, the predominant form of boron in seawater, is a nonpolar molecule that is challenging to remove via electromembrane processes. Removal of the non-ionized form of boron is challenging and limited even in RO membranes; therefore, boron-specific membranes are often required.

Regarding brine discharge, the concentrate stream from the first ICP stage is recycled for use as electrode rinsing flow to eliminate the need for a pumping system for the electrode rinse. This design inevitably results in a lower overall recovery rate (˜2.5%) to retain an effective electrode rinsing flow rate. Still, it allows only a slightly elevated concentration of released brine (˜36 g/L) from incoming seawater, minimizing any environmental impact caused by brine release. The unit consumes 9.4 W of total power (=28.3 Wh/L of SEC with 0.33 L/h of production rate, FIG. 54), of which 70% is consumed by the 2ICP/ED module (=6.6 W) and 30% by the pumps (=2.8 W). The SEC of the 2ICP/ED module in the unit (=20.0 Wh/L) shows a level similar to the SEC observed in the lab setting experiment. The power consumption by the controller is negligible at the level of 0.1 W. Although the current overall SEC is ˜ 28.3 Wh/L, there is much room for improvement in energy efficiency because the contribution of power consumption by electrodes and pumps decreases as the production rate increases.

### Discussion

Herein, we demonstrated the feasibility of a fully integrated, lightweight, and deployable seawater desalination system by combining recent innovations in electromembrane processes. The 2ICP/ED process successfully produced drinkable water from brackish water (2.5˜10 g/L) and seawater (30˜45 g/L). In addition, up to 30 NTU turbidity was reduced below 1 NTU (representing crystal-clear water). The portable desalination system successfully removed the most relevant ions, meeting WHO drinking water guidelines in the field testing using natural seawater from Carson Beach, which is near Boston, Massachusetts, USA. The only exception was the limited removal efficiency of the boron compound, which is not surprising because boron is nonpolar and, therefore, challenging to remove. Even using reverse osmosis (RO), which is a size-based separation process, boron is challenging to remove, and special arrangements are made to ensure its removal.

The recovery rate of the system (˜2.5%) was relatively low because this design utilizes some of the brine as the electrode rinsing solution. We believe that the low recovery rate is not functionally limiting in the portable desalination system, which is designed to produce a small amount of drinkable water out of a practically unlimited amount of environmental seawater available. The low recovery rate also ensures that our brine output is of almost the same salinity as the input (<2% increase), therefore ensuring minimal (if any, considering the small volume we were processing) environmental impact by releasing the brine back into the ocean. The total power consumption (<10 W) is low enough to support field operation powered by a modest-sized solar panel (typically 150˜200 W/m²) or battery packs (Li-ion batteries of 100˜ 265 Wh/kg), without drastically increasing the system size or weight for portable operation. On the other hand, we demonstrate many functional and operational features that are believed to be unique and unprecedented, such as co-removal of total suspended solids (TSS) and total dissolved solids (TDS) directly from the seawater in a single step (i.e., no pretreatment), long-term operation with no polarity reversal, integrated design for electrode washing (no need for separate electrode washing solution), and minimally enriched brine release. These features are believed to be more advantageous to the portable desalination system than achieving the lowest possible energy efficiency, which will inevitably lead to a larger membrane size or lower production rate.

The net cost of generating drinkable water per volume using the system described herein is expected to be higher than that of typical RO desalination plants, mainly due to the engineering constraints related to portable systems. However, many features of the system described herein, including low maintenance and pretreatment need, low power consumption, and generally low capital cost requirement (compared with RO), make this device an attractive option for solving a wide array of current water challenges, filling the critical gap that is not met by existing desalination technologies.

### Device Fabrication:

The fabrication, configuration, and operation of a bench-top-scale system for an ICP process with a return-flow spacer is described in Yoon, J.; Do, V. Q.; Pham, V.-S.; Han, J., “Return Flow Ion Concentration Polarization Desalination: A New Way to Enhance Electromembrane Desalination,” 159 Water Research 501-510 (2019). The bench-top ICP process is stacked with alternating CEMs and the return-flow mesh spacers (as described in US 2020/0308028 A1) between two electrode compartments. The spacers can define channels for the diluate and concentrate flows. A NAFION N115 membrane (from Fuel Cell Store, CO, USA) is used for CEM between spacers, and a RALEX CMHPES membrane (from Mega, Czechia) is used for the isolating membrane next to the electrodes. The return-flow spacer has three channels, diluate, intermediate, and concentrate channel, separated by a porous membrane (a poly-carbonate membrane filter with 200 nm pore and 24 mm of thickness, PCTE0220030 from Sterlitech Co., Kent, WA, USA). The intermediate channel is made by cutting a 1.6-mm-thick acrylic sheet with a laser cutter (PLS6.150D, Universal Laser System Inc., Scottsdale, AZ). The porous membranes are placed on both sides of the intermediate channel. Silicon rubber (with 300 μm-thickness is from Greene Rubber Company, Woburn, Massachusetts, USA) is used as a gasket for the diluate and concentrate channels, and a woven mesh is placed in the channels. The total thickness of the return-flow spacer, including three channels, is 2.2 mm with 15×5 cm² of the effective membrane area. The electrode compartments comprise a laser-cut acrylic frame, Ru-Ir coated Titanium plates (from Baoji Qixin Titanium Co., LTD., China), and a rinsing channel.

### System Operation and Measurement:

Artificial sea salt (ASTM D1141-98 from Lake Products Company LLC, Florissant, Missouri, USA) is used to prepare solutions with 2.5, 5, and 10 g/L of concentration to represent brackish water and with 30, 35, 40, and 45 g/L of salt concentration to prepare artificial seawater. The natural seawater solution is collected from Carson Beach, Boston, Massachusetts, USA. Sodium sulfate solution prepared from sodium sulfate (239313) from Sigma-Aldrich (St. Louis, Missouri, USA) with a concentration of 0.6M is used as the rinsing solution. A peristaltic pump (MASTERFLEX L/S pump, Cole-Parmer Instrument Company, LLC., Vernon Hills, Illinois, USA) is used to apply all feed solutions. Flow rates of diluate and concentrate outlets are adjusted by needle valves (7792K55 valves, McMaster-Carr, Aurora, Ohio, USA) and monitored by a flowmeter (4350K45 flowmeter, McMaster-Carr). The change of conductivity is monitored by a flow-through conductivity probe (16-900 Flow-thru Conductivity Electrode, Microelectrodes, Inc., Bedford, NH, USA) in a real-time manner. After the conductivity of the diluate stream is saturated, 10 ml of the collected solution is measured again by electrode conductivity cell (013610MD, Thermo Fisher Scientific Inc., Cambridge, Massachusetts, USA). The DC power supply (BK9205, B&K Precision Corp., Yorba Linda, CA, USA) was used to apply constant current or voltage.

### Gravity-Fed Flow Operation:

A 40-L water tank filled with artificial seawater is placed above the ICP module to generate a gravity-fed flow. Artificial seawater is supplied to the desalination unit after passing through the filter (4422K4 filter, McMaster-Carr) that removes particle size down to 5 microns. The voltage regulator (DROK, China) is used to supply constant voltage connected to the portable battery (a JACKERY EXPLORER 240 battery from Jackery Inc., Freemont, CA, USA). The flow rate of three streams, the concentrate stream of the first stage and diluate, and concentrate streams of the third stage (ED) are controlled by needle valves and are monitored by flow meters.

The size and zeta potential of suspended solids were measured by a Z1 COULTER COUNTER particle analyzer (from Beckman Coulter, Fullerton, CA, USA) and a ZETASIZER NANO ZS particle analyzer (from Malvern Instruments, UK), respectively. The ionic composition of seawater, product water, and brine from the field testing were measured by inductively coupled plasma-optical emission spectrometer (ICP-OES, 5100 VDV, from Agilent Technologies, Santa Clara, California, USA).

In describing embodiments, herein, specific terminology is used for the sake of clarity. For the purpose of description, specific terms are intended to at least include technical and functional equivalents that operate in a similar manner to accomplish a similar result. Additionally, in some instances where a particular embodiment includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments, those parameters or values can be adjusted up or down by 1/100^{th}, 1/50^{th}, 1/20^{th}, 1/10^{th}, 1/5^{th}, 1/3^{rd}, 1/2, 2/3^{rd}, 3/4^{th}, 4/5^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof or within a range of the specified parameter up to or down to any of the variations specified above (e.g., for a specified parameter of 100 and a variation of 1/100^{th}, the value of the parameter may be in a range from 0.99 to 1.01), unless otherwise specified. Further still, where methods are recited and where steps/stages are recited in a particular order—with or without sequenced prefacing characters added for ease of reference—the steps/stages are not to be interpreted as being temporally limited to the order in which they are recited unless otherwise specified or implied by the terms and phrasing.

Additional examples consistent with the present teachings are set out in the following numbered clauses:
1. A sequentially stacked multi-stage desalination system, comprising:
   a single pair of electrodes, comprising an anode and a cathode;
   at least one ion concentration polarization device; and
   at least one electrodialysis device coupled with the at least one ion concentration polarization device and configured to receive liquid flow from the at least one ion concentration polarization device,
   wherein each ion concentration device and electrodialysis device is positioned between the anode and the cathode.
2. The sequentially stacked multi-stage desalination system of clause 1, wherein the at least one ion concentration polarization device comprises a first-stage ion concentration polarization device and a second-stage ion concentration polarization device connected in series for liquid flow from the first-stage ion concentration polarization device to the second-stage ion concentration polarization device, and wherein the at least one electrodialysis device is configured to receive liquid flow from the second-stage ion concentration polarization device.
3. The sequentially stacked multi-stage desalination system of clause 1 or 2, wherein the at least one electrodialysis device comprises a first-stage electrodialysis device and a second-stage electrodialysis device connected in series for liquid flow from the first-stage electrodialysis device to the second-stage electrodialysis device, and wherein the first-stage electrodialysis device is configured to receive liquid flow from the at least one ion concentration polarization device.
4. The sequentially stacked multi-stage desalination system of any of clauses 1-3, further comprising a source of aqueous saline solution in fluid communication with the at least one ion concentration polarization device.
5. The sequentially stacked multi-stage desalination system of clause 1 or 2, wherein the at least one electrodialysis device comprises a stack of at least one cell set comprising the following layers: an anion exchange membrane, a spacer, and a cation exchange membrane.
6. The sequentially stacked multi-stage desalination system of any of clauses 1-5, further comprising a power source selected from a battery and a solar panel electrical coupled with the electrodes.
7. The sequentially stacked multi-stage desalination system of any of clauses 1-6, wherein the system is pump-free, and wherein the system is configured for driving liquid flow therethrough via gravity.
8. The sequentially stacked multi-stage desalination system of any of clauses 1-7, wherein the system has dimensions that are all less than 1 m.
9. The sequentially stacked multi-stage desalination system of any of clauses 1-7, wherein the system has dimensions that are all less than 0.5 m.
10. The sequentially stacked multi-stage desalination system of any of clauses 1-9, wherein the system has a mass that less than 20 kg.
11. The sequentially stacked multi-stage desalination system of any of clauses 1-9, wherein the system has a mass that less than 10 kg.
12. A method for sequentially stacked multi-stage desalination using the sequentially stacked multi-stage desalination system of any of clauses 1-9, the method comprising:
   flowing an aqueous saline solution into the at least one ion concentration polarization device;
   extracting ions from the aqueous saline solution in the at least one ion concentration polarization device to produce a concentrated brine and a diluate;
   flowing the diluate from the at least one ion concentration polarization device into the at least one electrodialysis device; and
   extracting additional ions from the diluate of the at least one ion concentration polarization device in the at least one electrodialysis device to produce a purified diluate.
13. The method of clause 12, using the apparatus of clause 2, further comprising:
   producing a first-stage diluate with the first-stage ion concentration polarization device;
   flowing the first-stage diluate from the first-stage ion concentration polarization device into the second-stage ion concentration polarization device; and
   extracting additional ions from the first-stage diluate in the second-stage ion concentration polarization device to produce additional concentrated brine and a second-stage diluate that flows as the diluate into the at least one electrodialysis device.
14. The method of clause 12 or 13, using the apparatus of clause 3, further comprising:
   flowing the diluate and concentrated brine from the at least one ion concentration polarization device into the first-stage electrodialysis device;
   extracting additional ions from the diluate of the at least one ion concentration polarization device in the first-stage electrodialysis device to produce a first-stage concentrated brine and a first-stage diluate;
   flowing the first-stage concentrated brine and first-stage diluate from the first-stage electrodialysis device into the second-stage electrodialysis device; and
   extracting additional ions from the diluate of the first-stage electrodialysis device to produce a second-stage concentrated brine and a second-stage diluate.
15. The method of any of clauses 12-14, wherein the flow of the aqueous saline solution, and the diluate through the system is driven by gravity.
16. The method of clause 12-15, wherein the purified diluate is water with a salinity of less than 0.6 g/L.
17. The method of any of clauses 12-16, wherein the aqueous saline solution has a salinity in a range from 2.5 to 45 g/L.
18. The method of any of clauses 14-17, wherein the first-stage and second-stage ion concentration polarization devices remove more than 90% of suspended solids from the aqueous saline solution.
19. The method of clause 18, wherein the aqueous saline solution is not subject to a pre-treatment to remove suspended solids before it flows into the first-stage ion concentration polarization device.
20. The method of any of clauses 12-19, further comprising recycling the concentrated brine from (a) the at least one ion concentration polarization device to rinse at least one of the anode and the cathode.
21. The method of clause 20, further comprising further recycling the concentrated brine after rinsing at least one of the anode and the cathode to then rinse the cathode if the anode was first rinsed or to then rinse the anode if the cathode was first rinsed.

While this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention.

What is claimed is:

1. A sequentially stacked multi-stage desalination system, comprising:
a single pair of electrodes, comprising an anode and a cathode;
at least one ion concentration polarization device; and
at least one electrodialysis device coupled with the at least one ion concentration polarization device and configured to receive liquid flow from the at least one ion concentration polarization device,
wherein each ion concentration device and electrodialysis device is positioned between the anode and the cathode.

2. The sequentially stacked multi-stage desalination system of claim 1, wherein the at least one ion concentration polarization device comprises a first-stage ion concentration polarization device and a second-stage ion concentration polarization device connected in series for liquid flow from the first-stage ion concentration polarization device to the second-stage ion concentration polarization device, and wherein the at least one electrodialysis device is configured to receive liquid flow from the second-stage ion concentration polarization device.

3. The sequentially stacked multi-stage desalination system of claim 1, wherein the at least one electrodialysis device comprises a first-stage electrodialysis device and a second-stage electrodialysis device connected in series for liquid flow from the first-stage electrodialysis device to the second-stage electrodialysis device, and wherein the first-stage electrodialysis device is configured to receive liquid flow from the at least one ion concentration polarization device.

4. The sequentially stacked multi-stage desalination system of claim 1, further comprising a source of aqueous saline solution in fluid communication with the at least one ion concentration polarization device.

5. The sequentially stacked multi-stage desalination system of claim 1, wherein the at least one electrodialysis device comprises a stack of at least one cell set comprising the following layers: an anion exchange membrane, a spacer, and a cation exchange membrane.

6. The sequentially stacked multi-stage desalination system of claim 1, further comprising a power source selected from a battery and a solar panel electrical coupled with the electrodes.

7. The sequentially stacked multi-stage desalination system of any claim 1, wherein the system is pump-free, and wherein the system is configured for driving liquid flow therethrough via gravity.

8. The sequentially stacked multi-stage desalination system of claim 1, wherein the system has dimensions that are all less than 1 m.

9. The sequentially stacked multi-stage desalination system of claim 1, wherein the system has dimensions that are all less than 0.5 m.

10. The sequentially stacked multi-stage desalination system of claim 1, wherein the system has a mass that less than 20 kg.

11. The sequentially stacked multi-stage desalination system of claim 1, wherein the system has a mass that less than 10 kg.

12. A method for sequentially stacked multi-stage desalination using the sequentially stacked multi-stage desalination system of claim 1, the method comprising:
flowing an aqueous saline solution into the at least one ion concentration polarization device;
extracting ions from the aqueous saline solution in the at least one ion concentration polarization device to produce a concentrated brine and a diluate;
flowing the diluate from the at least one ion concentration polarization device into the at least one electrodialysis device; and
extracting additional ions from the diluate of the at least one ion concentration polarization device in the at least one electrodialysis device to produce a purified diluate.

13. The method of claim 12, wherein the at least one ion concentration polarization device comprises a first-stage ion concentration polarization device and a second-stage ion concentration polarization device connected in series for liquid flow from the first-stage ion concentration polarization device to the second-stage ion concentration polarization device, and wherein the at least one electrodialysis device is configured to receive liquid flow from the second-stage ion concentration polarization device, the method further comprising:
producing a first-stage diluate with the first-stage ion concentration polarization device;
flowing the first-stage diluate from the first-stage ion concentration polarization device into the second-stage ion concentration polarization device; and
extracting additional ions from the first-stage diluate in the second-stage ion concentration polarization device to produce additional concentrated brine and a second-stage diluate that flows as the diluate into the at least one electrodialysis device.

14. The method of claim 12, wherein the at least one electrodialysis device comprises a first-stage electrodialysis device and a second-stage electrodialysis device connected in series for liquid flow from the first-stage electrodialysis device to the second-stage electrodialysis device, and wherein the first-stage electrodialysis device is configured to receive liquid flow from the at least one ion concentration polarization device, the method further comprising:
flowing the diluate and concentrated brine from the at least one ion concentration polarization device into the first-stage electrodialysis device;
extracting additional ions from the diluate of the at least one ion concentration polarization device in the first-stage electrodialysis device to produce a first-stage concentrated brine and a first-stage diluate;
flowing the first-stage concentrated brine and first-stage diluate from the first-stage electrodialysis device into the second-stage electrodialysis device; and
extracting additional ions from the diluate of the first-stage electrodialysis device to produce a second-stage concentrated brine and a second-stage diluate.

15. The method of claim 14, wherein the first-stage and second-stage ion concentration polarization devices remove more than 90% of suspended solids from the aqueous saline solution.

16. The method of claim 15, wherein the aqueous saline solution is not subject to a pre-treatment to remove suspended solids before it flows into the first-stage ion concentration polarization device.

17. The method of claim 12, wherein the flow of the aqueous saline solution and the diluate through the system is driven by gravity.

18. The method of claim 12, wherein the purified diluate is water with a salinity of less than 0.6 g/L.

19. The method of claim 12, wherein the aqueous saline solution has a salinity in a range from 2.5 to 45 g/L.

20. The method of claim 12, further comprising recycling the concentrated brine from (a) the at least one ion concentration polarization device to rinse at least one of the anode and the cathode.

21. The method of claim 20, further comprising further recycling the concentrated brine after rinsing at least one of the anode and the cathode to then rinse the cathode if the anode was first rinsed or to then rinse the anode if the cathode was first rinsed.
